(19) United States
(12) Patent Application Publication
(10) Pub. No.: US 2007/0203691 A1
(43) Pub. Date: Aug. 30, 2007

(54) Translator support program, translator support device and translator support method

(75) Inventors: Seiji Okura, Kawasaki (JP); Tomoki Nagase, Kawasaki (JP); Masaru Fuji, Kawasaki (JP); Akira Ushioda, Kawasaki (JP); Akinari Masuyama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/514,970

(22) Filed: Sep. 5, 2006

(30) Foreign Application Priority Data
Feb. 27, 2006 (JP) 2006-051255

(51) Int. Cl. G06F 17/28

(52) U.S. Cl. 704/3

(57) ABSTRACT

A translator support device consists of a display device, an input device, and a main body to which these devices are connected. The main body has a CPU, a DRAM, a MD, and a HDD built-in. A translator support software is installed in the HDD. The translator support software consists of a program group and a data group that operate a computer as a device to support a translator. The translator support software includes a machine translation module, a dictionary database, a translation-memory-retrieval module, and a translation example database. When a translated phrase displayed on the display device is corrected, the translator support device retrieves units that include the correction portion from the database, reflects the correction to each of all the retrieved units.

### BACKGROUND OF THE INVENTION

The present invention relates to a translator support program, which operates a computer as a device for supporting a translator who translates a sentence, a translator support device that functions in the same manner as the computer on which such a translator support program runs, and a translator support method implemented by such a translator support device.

As is generally known, even if a sentence is long and complicated in structure, the sentence can be translated comparatively precisely and easily when the sentence is divided into some parts such as phrases and clauses that are translated separately and the translated parts are combined.

In recent years, a device to support a translator who performs an industrial translation by such a translation method (for example, see the international publication No. 2004/081813). FIG. 20 through FIG. 24 show examples of a working window 61 that is displayed on a conventional translator support device.

As shown in FIG. 19 through FIG. 23, the working window 61 includes a sentence list box 61a, an original sentence display box 61b, a translated sentence display box 61c, and a layer display box 61d. First lines of respective sentences are displayed in the sentence list box 61a. In addition, the whole of original sentence or one part thereof (referred to as an original phrase) is displayed in the original sentence display box 61b when one of the sentences displayed in the sentence list box 61a has been chosen as an original sentence (a translation target sentence). The translated result of the original sentence or the original phrase that is displayed in the original sentence display box 61b is displayed in the translated sentence display box 61c. The layer display box 61d is used for displaying a layer as an item to which each unit belongs when the original sentence is divided into some units in some layers by repeating operation to choose a part of the original sentence or the original phrase displayed in the original sentence display box 61b as a translation unit of a lower layer. In the layer display box 61d, any one of the items can be chosen. When any one of the items is chosen, the original phrase corresponding to the chosen item is displayed in the original sentence display box 61b.

The translation using the working window 61 will be described specifically. At first a translator chooses one sentence among a plurality of sentences displayed in the sentence list box 61a as an original sentence to display the whole of original sentence in the original sentence display box 61b (a state shown in FIG. 19). In the layer display box 61d, an item showing that the whole of original sentence is in the uppermost layer is displayed. Next the translator chooses a part such as a phrase or a clause in the original sentence displayed in the original sentence display box 61b by an operation such as a drag (the inverted part in FIG. 20 is chosen), and determines that the chosen part belongs in the lower layer by clicking a lower-layer-making button 61e in FIG. 20. In the layer display box 61d, an item showing an original phrase of the chosen unit as a lower layer is displayed and the original phrase of the chosen unit is displayed in the original sentence display box 61b (the state shown in FIG. 21). Further, the translator can determine that one part of the original phrase belongs in a still lower layer by clicking the lower-layer-making button 61e with choosing the part in the original phrase determined as the lower layer. When the translator clicks an assembling button 61f in FIG. 22 after repeating such an operation to establish some units in the layered structure (the state shown in FIG. 22), the translator support device executes machine-translation or searches a translation memory with respect to the original phrase shown in the original sentence display box 61b. Then, the device stores the obtained translation result (the translated phrase and inscription thereof) and displays it in the translated sentence display box 61c. Further, the translator support device registers the obtained translated result as a block that is incorporated in the translated phrase in the next-upper layer, when the original phrase displayed in the original sentence display box 61b has the next-upper layer. The translator can complete a translation of the sentence that has been chosen from the sentences in the sentence list box 61a by repeating the operation to click the assembling button 61f for all the layers except the uppermost layer (the state shown in FIG. 23).

In the conventional translator support device described above, a translator can correct the translated phrase displayed in the translated sentence display box 61c. Specifically, when the translator chooses any one of items in the layer display box 61d, the original phrase shown in the chosen item is displayed in the original sentence display box 61b and the corresponding translated phrase is displayed in the translated sentence display box 61c. When the translator corrects the translated phrase displayed in the translated sentence display box 61c, he or she clicks the assembling button 61f after finishing a correction such as a change, an addition and a deletion with respect to the translated phrase to update the translated phrase that is registered for the current item with the corrected translated phrase. Further, when there is a layer upper than the layer of the current item, the translator has to update the corresponding part in the translated phrase in the upper layer.

However, when the translator corrects the translated phrase in the lower layer, he or she must repeat the operations to choose an item and to click the assembling button 61f from the current layer to the upper layer step by step for reflecting the correction to the translated sentence of the original sentence registered in the uppermost layer. Further, when the translated phrase in the upper layer is displayed in the translated sentence display box 61c and he or she corrects the displayed phrase that are also include in the lower layer, the correction cannot be reflected to the translated phrase registered in the lower layer.

### SUMMARY OF THE INVENTION

In view of the above problems in the conventional art, the present invention has an object to provide a translator support program, a translator support device and a translator support method that is capable of reflecting a correction of a translated phrase in any one of layers to the corresponding translated phrases in all layers when a original sentence is divided so as to establish some units in a layered structure.

A translator support program according to the present invention operates a computer to have functions including, means for storing an original phrase, a translated phrase and identifying information of each of units that are established as translation units in a original sentence, and identifying information of a unit in a next-upper layer that includes the units into storage so as to be related with one another; means for displaying an original phrase and a translated phrase of any of all units in the original sentence on an display device; means for retrieving units, when a user's instruction to correct a translated phrase displayed on the display device by the displaying means is accepted, that includes parts to be corrected from units established in the translated phrase as lower layers; and means for propagating the correction by repeating a process to reflect the correction to a translated phrase in each of units in all the layers retrieved by the retrieving means from the lowermost layer to the uppermost layer.

With this construction, when a translated phrase displayed on the display device is corrected, units including the corrected portion are retrieved, and the correction is reflected to each of all the retrieved units in all the layers.

Further, a translator support device according to the present invention includes: a storing portion for storing an original phrase, a translated phrase and identifying information of each of units that are established as translation units in a original sentence, and identifying information of a unit in a next-upper layer that includes the units so as to be related with one another; a displaying portion for displaying an original phrase and a translated phrase of any of all units in the original sentence; a retrieving portion for retrieving units, when a user's instruction to correct a translated phrase displayed on the displaying portion is accepted, that includes parts to be corrected from units established in the translated phrase as lower layers; and a propagating portion for propagating the correction by repeating a process to reflect the correction to a translated phrase in each of units in all the layers retrieved by the retrieving portion from the lowermost layer to the uppermost layer.

Accordingly, the translator support device has the same function as the computer on which the translator support program described above is running.

Still further, a translator support method of the present invention includes a storing procedure for storing an original phrase, a translated phrase and identifying information of each of units that are established as translation units in a original sentence, and identifying information of a unit in a next-upper layer that includes the units into storage so as to be related with one another; a displaying procedure for displaying an original phrase and a translated phrase of any of all units in the original sentence on an display device; a retrieving procedure for making a computer retrieve units, when a user's instruction to correct a translated phrase displayed on the display device in the displaying procedure is accepted, that includes parts to be corrected from units established in the translated phrase as lower layers; and a propagating procedure for making a computer propagate the correction by repeating a process to reflect the correction to a translated phrase in each of units in all the layers retrieved in the retrieving procedure from the lowermost layer to the uppermost layer.

Accordingly, the translator support method is identical to the method achieved by the above-described translator support device of the present invention.

According to the present invention, when some units are established on an original sentence in multi-layered manner, a correction to a translated phrase of a unit in any layer is propagated to all the layers. That is, the translated phrases that contain the portion corresponding to the corrected portion are automatically corrected in all the layers.

### DESCRIPTION OF THE ACCOMPANYING DRAWINGS

FIG. 1 is a block diagram of a translator support device of an embodiment according to the present invention;

FIG. 2 through FIG. 9 are flowcharts for showing processes of a translator support program running on the device of FIG. 1;

FIG. 10 shows one example of a working window;

FIG. 11 shows one example of data structure of the working table;

FIG. 12 shows one example of the working window when items are displayed in a layer display box;

FIG. 13 shows a result window after translation by a translation-memory-retrieval module;

FIG. 14 is a flowchart for showing a layer generation process;

FIG. 15 is a flowchart for showing a lower layer translation process;

FIG. 16 shows the working window in which the translation result in FIG. 13 are displayed;

FIG. 17 shows one example of data structure of a translation sample database in which original sentences including variables and translated sentences are stored;

FIG. 18A and FIG. 18B show specific examples of embedded symbols; and

FIG. 19 through FIG. 23 show examples of working windows displayed on the conventional translator support device.

### DESCRIPTION OF THE PREFERRED EMBODIMENTS

Hereinafter, an embodiment of the present invention will be described in detail with reference to the attached drawings.

At first, a constitution of a translator support device according to the embodiment will be described.

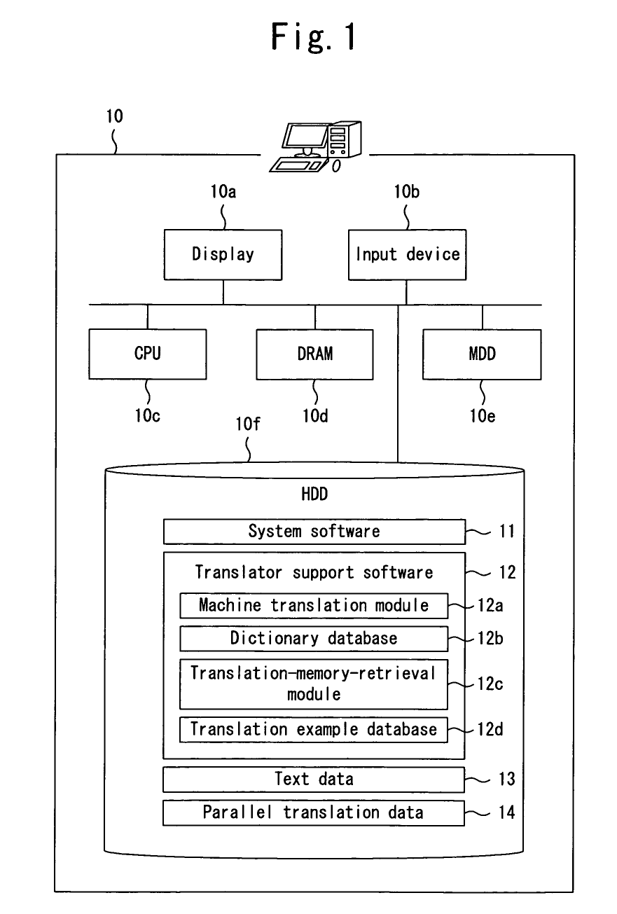

FIG. 1 is a block diagram showing the translator support device 10 of the embodiment.

As shown in FIG. 1, the translator support device 10 is a device to support a translator who translates a sentence. Specifically, the translator support device 10 is a personal computer on which translator support software is installed.

The personal computer constituting the translator support device 10 consists of a display device 10a such as a liquid crystal display, an input device 10b such as a keyboard and a mouse, and a main body to which these devices are connected. The main body has a CPU (Central Processing Unit) 10c, a DRAM (Dynamic Random Access Memory) 10d, a MDD (Multi Disk Drive) 10e, and a HDD (Hard Disk Drive) 10f built-in. System software is installed into the HDD 10f.

The system software 11 provides many kinds of application software with basic functions such as an input/output control in the display device 10a and the input device 10b, a read/write control of the memory area of the DRAM 10d and the memory areas of the MDD 10e, the HDD 10f (memory areas of a CD (Compact Disk), a DVD (Digital Versatile Disk) and a HD (Hard Disk)).

Furthermore, a translator support software 12 is installed in the HDD 10f.

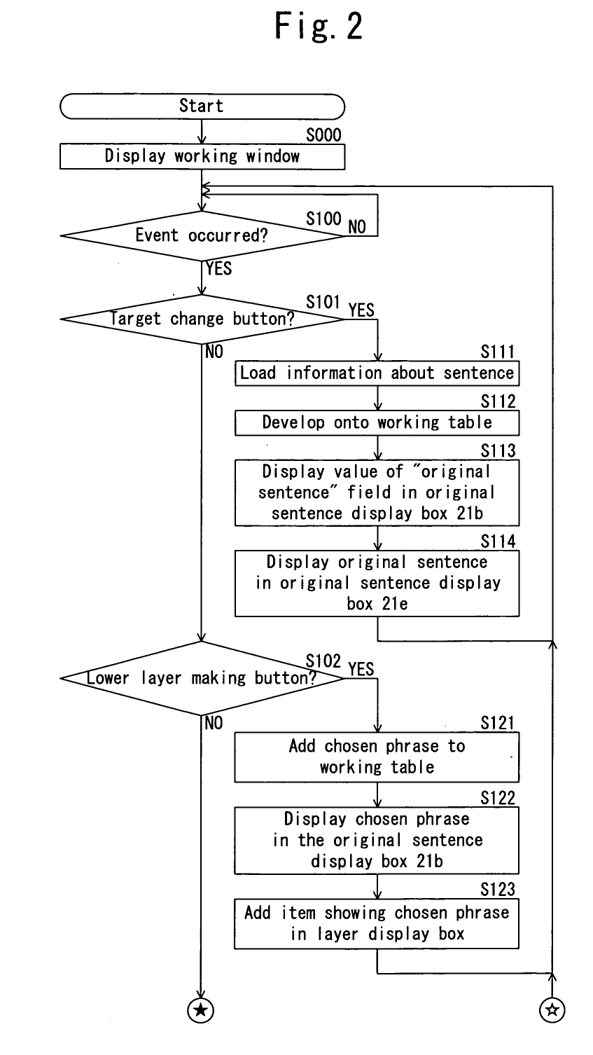

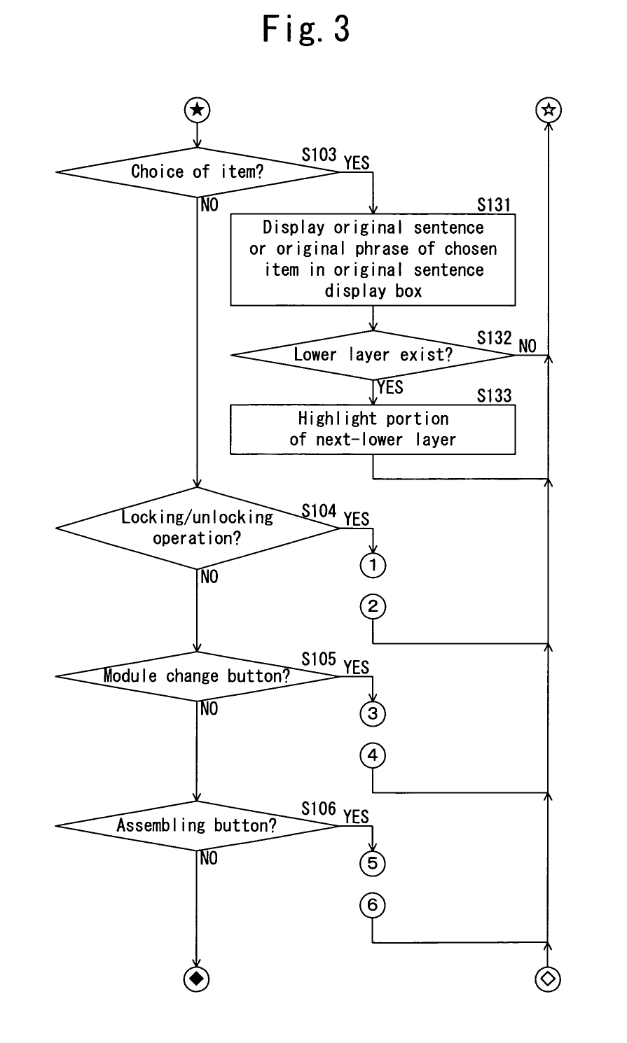

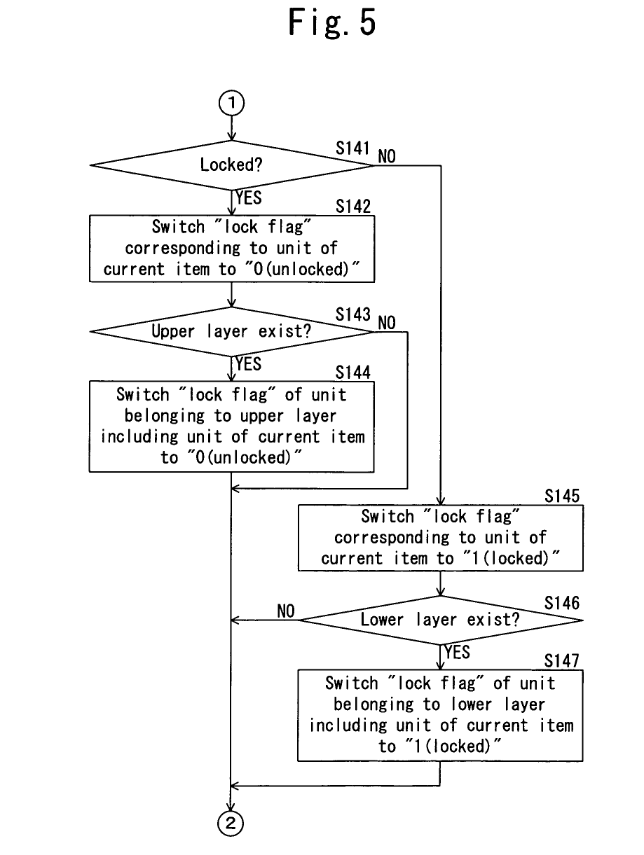

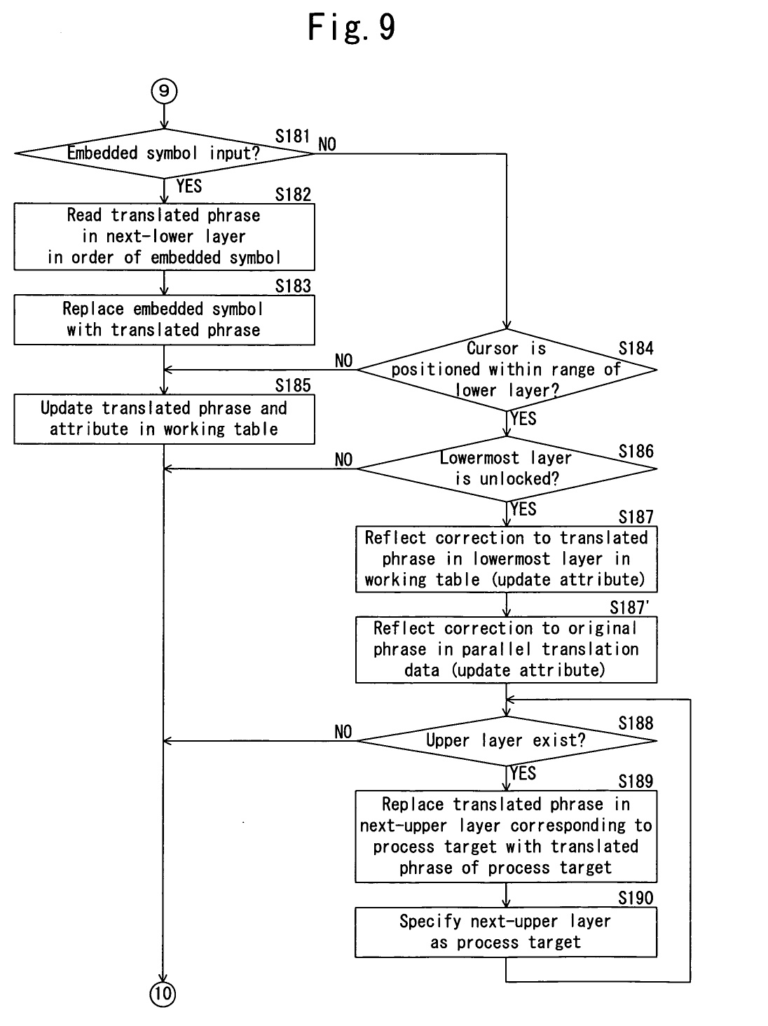

The translator support software 12 consists of a program group and a data group that operate a computer as a device to support a translator who translates a sentence. The translator support software 12 includes a machine translation module (program) 12a, a dictionary database 12b, a translation-memory-retrieval module (program) 12c, and a translation example database 12d as well as functions to perform processes described below with reference to FIG. 2 through FIG. 9.

The well-known machine translation module 12a will be described briefly. The machine translation module 12a acquires words or idioms in a target language corresponding to words and idioms in a sentence to be translated using the dictionary database 12b, which memorizes many pairs of words or idioms where each pair express the same contents in two languages, that is, a source language and a target language. Then, the module 12a analyzes the syntax of the sentence to be translated, converts the analyzed syntax into the syntax in the target language, and generates a translated sentence of the sentence to be translated by applying each word or idiom acquired in advance to the converted syntax.

Further, the well-known translation-memory-retrieval module 12c will be described briefly. The translation-memory-retrieval module 12c retrieves a sentence or a phrase that is identical to or similar to the sentence to be translated from the translation example database 12d, which memorizes many pairs of sentences or phrases where each pair express the same contents in two languages. Then, the module 12c outputs the sentence or phrase in the target language corresponding to the retrieved sentence or phrase in the source language as the translation result.

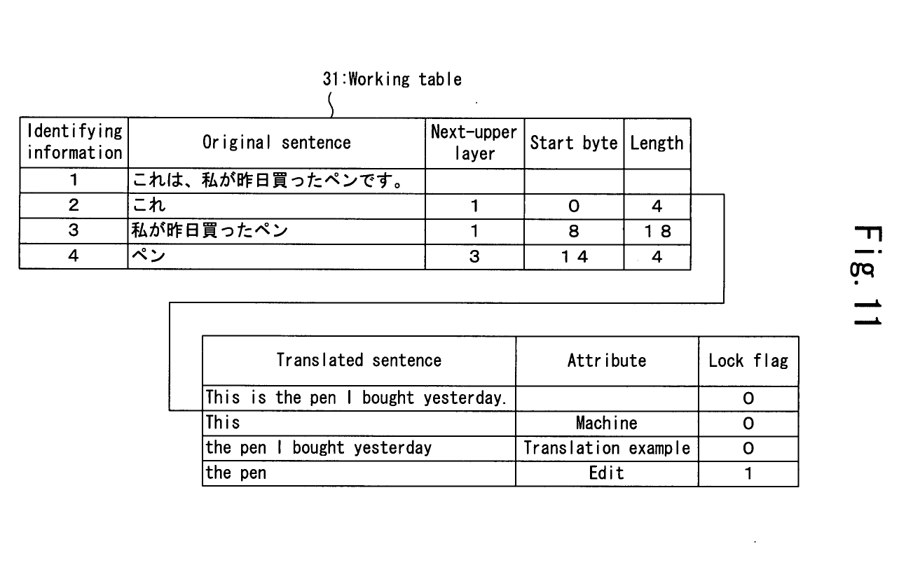

The HDD 10f stores text data 13 including many sentences that may be translation target as contents and parallel translation data 14 generated by the translator support software 12. The parallel translation data 14 has tables for the sentences that are the contents of the text data 13, respectively. Each the table includes the same contents as that in a working table 31 shown in FIG. 11 described below. The parallel translation data 14 is generated when a translator starts the translator support software 12 and it loads the text data 13.

In addition, the translator support device 10 that stores the parallel translation data 14 in the HDD 10f and the DRAM 10d corresponds to the storing means described above.

Next, the processes executed by the translator support device 10 of the embodiment will be described.

When the parallel translation data 14 is chosen by an operator who operates the input device 10b, the CPU 10c of the translator support device 10 loads the translator support software 12 from the HDD 10f to start a translator support process.

FIG. 2 through FIG. 9 are flowcharts showing a flow of the translator support process.

After starting the translator support process, the CPU 10c performs a process to display a working window in the display device 10a in the first step S000.

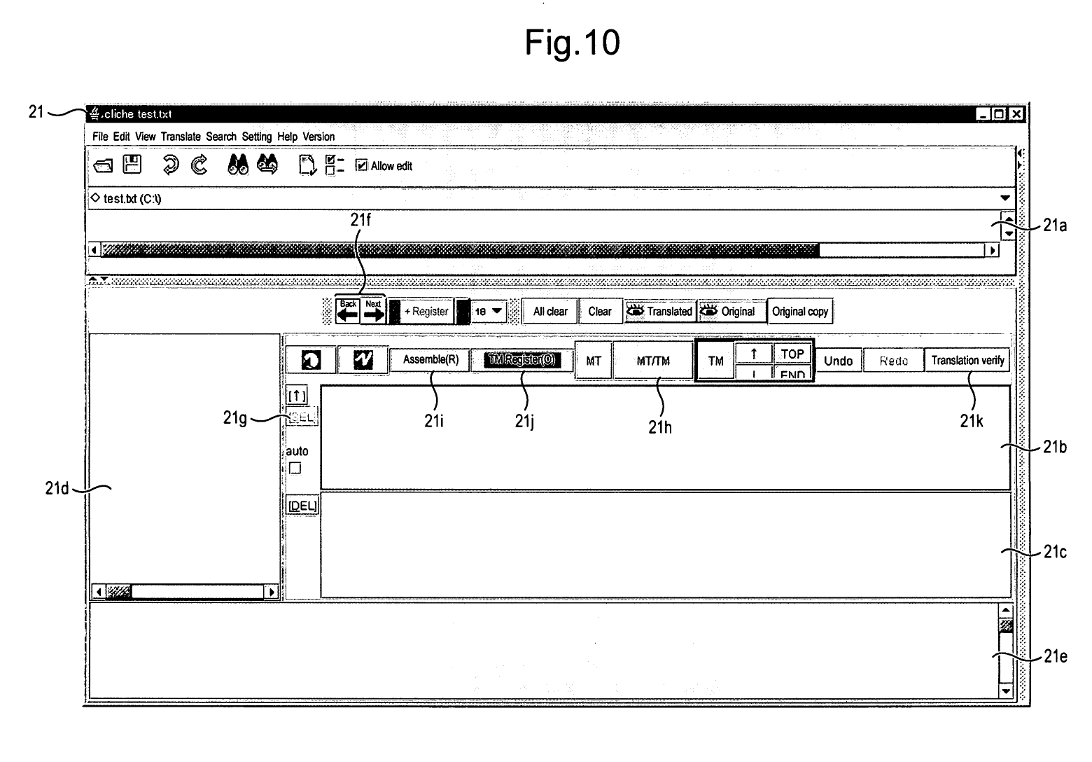

FIG. 10 shows one example of the working window 21.

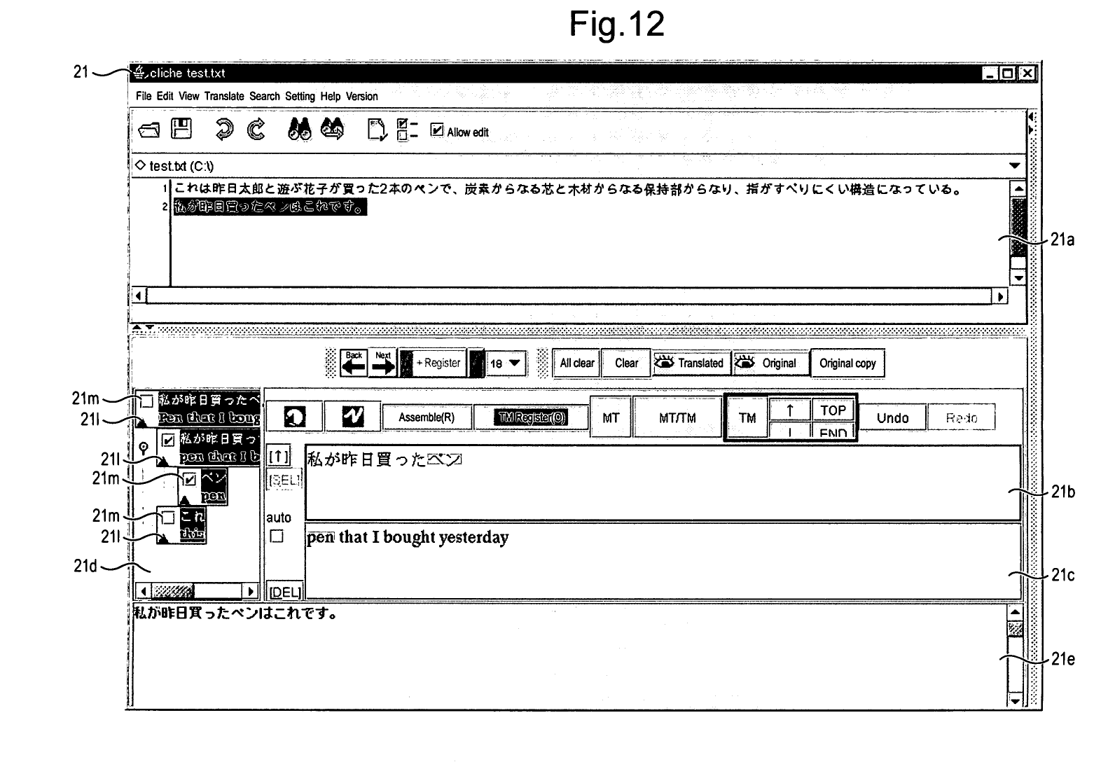

As shown in FIG. 10, the working window 21 includes a sentence list box 21a, an original sentence display box 21b, a translation display box 21c, a layer display box 21d, and an original sentence display box 21e. First lines of respective sentences are displayed in the sentence list box 21a. In addition, the whole of original sentence or one part thereof (referred to as an original phrase) is displayed in the original sentence display box 21b when one of the sentences displayed in the sentence list box 21a has been chosen as an original sentence (a translation target sentence). The translated result of the original sentence or the original phrase that is displayed in the original sentence display box 21b is displayed in the translated sentence display box 21c. A translated result of an original sentence is referred to as a translated sentence, and a translated result of an original phrase is referred to as a translated phrase. In addition, the translated sentence displayed in the translation display box 21c can be edited, that is, added, deleted or changed, to enable a correction of the translated sentence. The layer display box 21d is used for displaying a layer as an item to which each unit belongs when some units are established in multi-layered manner on the original sentence by repeating operation to choose a part of the original sentence or the original phrase displayed in the original sentence display box 21b as a translation unit of a lower layer (see the same box in FIG. 12). In addition, the items displayed in the layer display box 21d function as clickable buttons. When any item is chosen by a click, the original sentence or the original phrase in the layer of the chosen item is displayed in the original sentence display box 21b. The whole of original sentence is displayed in the original sentence display box 21e. Even if the original sentence display box 21b displays only an original phrase (in other words, one part of an original sentence), the original sentence display box 21e displays the whole original sentence.

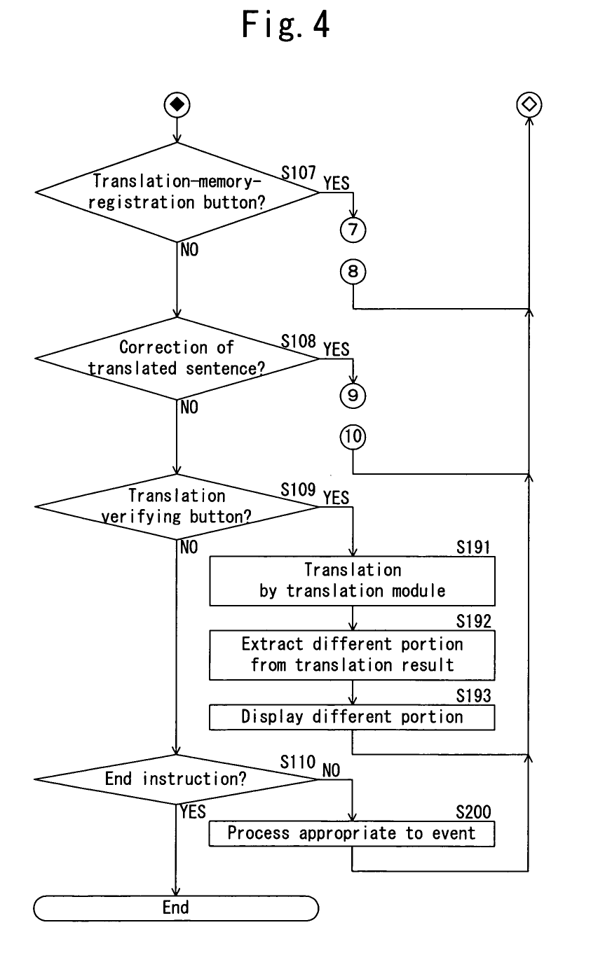

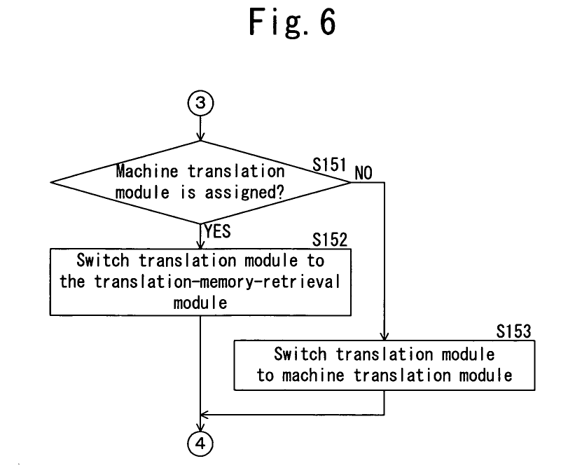

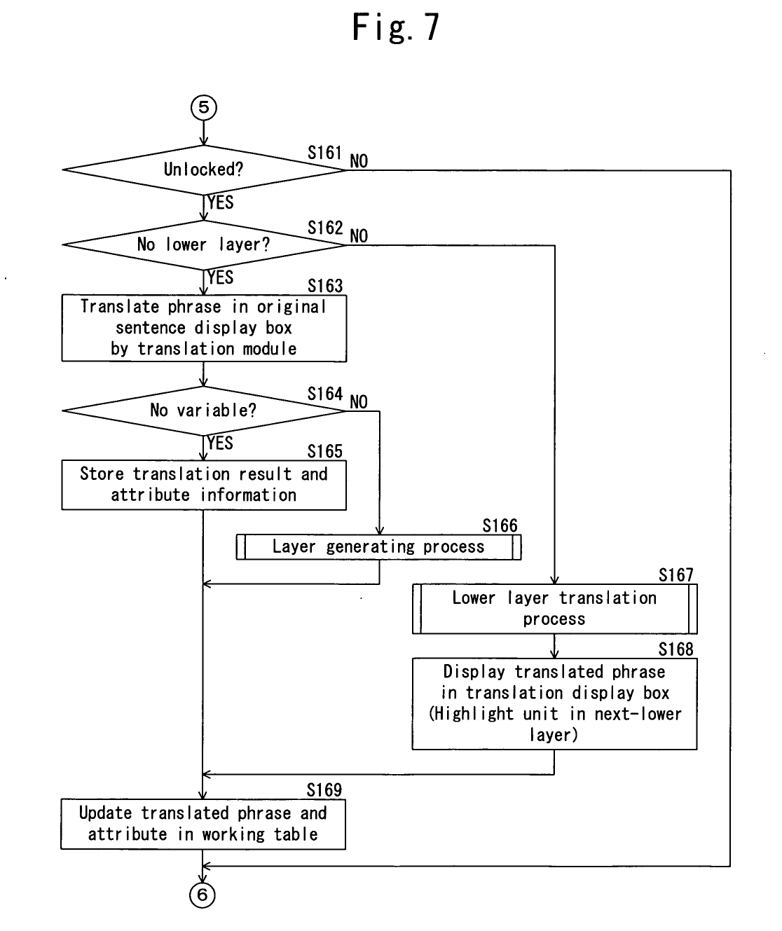

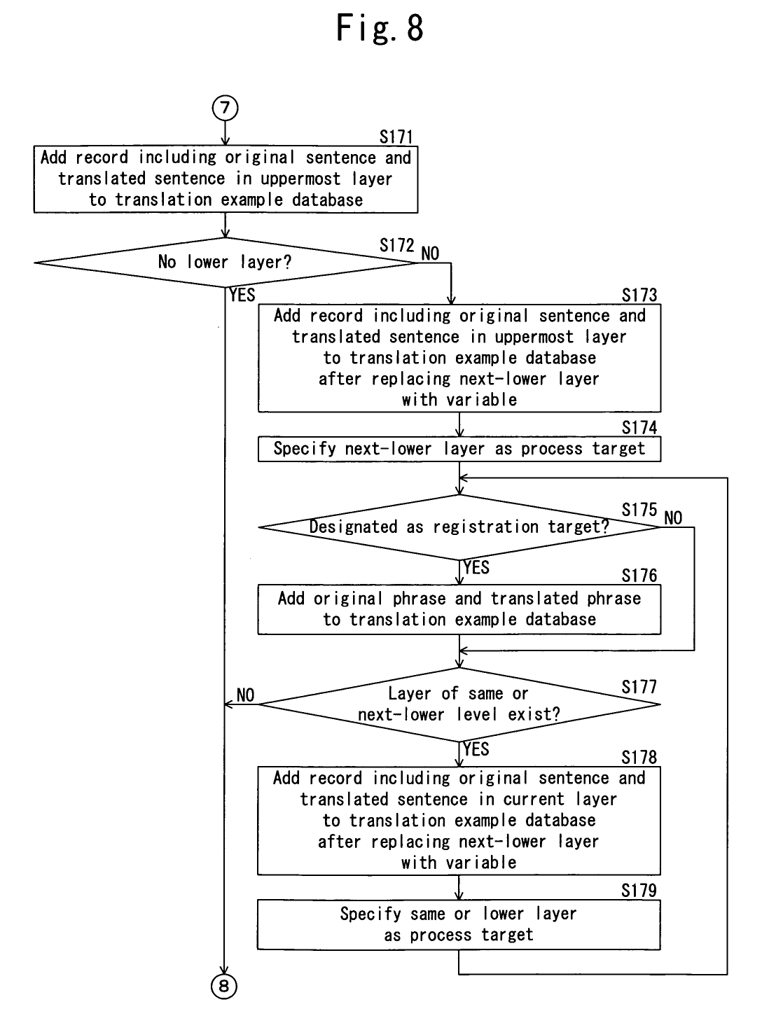

Further, the working window 21 includes a pair of target change buttons 21f, a lower-layer-making button 21g, a module switching button 21h, an assembling button 21i, a translation-memory-registration button 21j, and a translation verifying button 21k. The pair of the target change buttons 21f are used to move a cursor displayed on any one lines in the sentence list box 21a to the upper line or the lower line. The sentence on which the cursor is overlapped becomes a sentence designated as an original sentence. The lower-layer-making button 21g is used to register a chosen part of an original sentence or an original phrase displayed in the original sentence display box 21b by a drag operation as that in the lower layer of the original sentence or phrase (see FIG. 2). In addition, the lower-layer-making button 21g does not function when one part of a sentence is not chosen by a drag operation. The module switching button 21h switches the translation module used when the assembling button 21i is clicked between the machine translation module 12a and the translation-memory-retrieval module 12c (see FIG. 6). The assembling button 21i is used to make the designated translation module generate a translated sentence or a translated phrase corresponding to the original sentence or the original phrase displayed in the original sentence display box 21b and generate translated phrases corresponding to the original phrases in all the lower layers established to the original sentence or the original phrase displayed in the original sentence display box 21b (see FIG. 7). The translation-memory-registration button 21j is used to register the original sentence or the original phrase displayed in the original sentence display box 21b, the translated sentence or the translated phrase displayed in the translation display box 21c, and original phrases and translated phrases in the lower layers thereof into the translation example database 12d (see FIG. 8). The translation verifying button 21k is used to display different portions between the translated sentence or the translated phrase displayed in the translation display box 21c and a translated result by the translation module (see FIG. 4).

Displaying the working window 21 as shown in FIG. 10 on the display device 10a, the CPU 10c proceeds the process from step S000 to step S100.

The CPU 10 that displays the working window 21 including the original sentence display box 21b and the translation display box 21c according to the step S000 corresponds to the displaying means described above.

In step S100, the CPU 10c waits until an event occurs. The events include a click of any of buttons 21f through 21k, a choice (a click) of any of items in the layer display box 21d, locking/unlocking operations (described below) of any of items in the layer display box 21d, a correction of a translated sentence displayed in the translation display box 21c, a finish instruction (a click of a finish button in a file menu), and so on.

The CPU 10c proceeds the process from step S100 to step S101 when an event occurs during the wait.

In step S101, the CPU 10c determines whether the event occurred in step S100 is a click of the target change button 21f or not.

The CPU 10c branches the process from step S101 to step S111 when the event occurred in step S100 is a click of the target change button 21f.

In step S111 the CPU 10c loads information about a sentence on which the cursor is overlapped in the sentence list box 21a from the parallel translation data 14 designated on startup.

In the next step S112, the CPU 10c develops the information loaded in step S111 onto the working table.

FIG. 11 shows one example of the data structure of the working table 31.

As shown in FIG. 11, the working table 31 has a record about the whole original sentence and records that are the same in number as units established as translation units on the original sentence. Each record has fields of “identification information”, an “original sentence”, a “next-upper layer”, a “start byte”, a “length”, a “translated sentence”, an “attribute” and a “lock flag”.

Identification information to distinguish the unit from other units individually is recorded in the “identification information” field. An original sentence or an original phrase is recorded in the “original sentence” field. Identification information of a unit in the next-upper layer that includes the current unit is recorded in the “next-upper layer” field. In addition, the “next-upper layer” field of the uppermost layer becomes blank because there is no next-upper layer. The start byte and length of the current unit in the original sentence or the original phrase in the next-upper layer are recorded in the “start byte” field and the “length” field, respectively. A translated sentence (a sentence in the uppermost layer after translation) of an original sentence (a sentence in the uppermost layer before translation) or a translated phrase (a phrase in a lower layer except the uppermost layer after translation) of an original phrase (a phrase in a lower layer except the uppermost layer before translation) is recorded in the “translated sentence” field. In addition, when the process to generate a translated sentence or a translated phrase is not registered in the step-by-step translation data 14 or the working table 31, the “translated sentence” field becomes blank. Attribute information showing whether the translated sentence or the translated phrase is generated by the machine translation module 12a (machine) or is generated by the translation-memory-retrieval module 12c (translation example) or is corrected by an operator (edit) is recorded in the “attribute” field. A lock flag defining whether a translated sentence or a translated phrase may be corrected or not is recorded in the “lock flag” field. The lock flag “0” shows an unlocked state where the translated sentence or a translated phrase can be edited.

The CPU 10c that memorizes the working table 31 in the DRAM 10d according to step S111 corresponds to the storing means described above.

The CPU 10c proceeds the process from step S112 to step S113 after developing the information loaded in step S111 to the working table 31.

In step S113, the CPU 10c executes a process to display the value of the “original sentence” field (original sentence) of the record in the uppermost layer in the working table 31 to which the information is developed in step S112 in the original sentence display box 21b of the working window 21 shown in FIG. 10. Further, when a value (translated sentence) is stored in the “translated sentence” field of the current record, the CPU 10c executes a process to display the value (translated sentence) in the translation display box 21c of the working window 21. However, when the “translated sentence” field is blank, the translation display box 21c becomes also blank. Furthermore, the CPU 10c executes a process to display items corresponding to the respective records in the working table 31 in the layer display box 21d.

In the next step S114, the CPU 10c executes a process to display the same sentence as the original sentence, which is displayed in the original sentence display box 21b in step S113, in the original sentence display box 21e.

And then, the CPU 10c returns the process from step S114 to step S100 after displaying the whole original sentence in the original sentence display box 21e, and waits until an event occurs.

In addition, the CPU 10c that executes the process from S111 to S114 corresponds to the displaying means described above.

On the other hand, when the event occurs in step S100 is not a click of the target change button 21f (S101, No), the CPU 10c proceeds the process from step S101 to step S102.

In step S102, the CPU 10c determines whether the event occurred in step S100 is a click of the lower-layer-making button 21g or not.

And then, when the event occurred in step S100 is a click of the lower-layer-making button 21g, the CPU 10c branches the process from step S102 to step S121.

In step S121, the CPU 10c executes a process to add the phrase, which has been chosen at the time when the lower-layer-making button 21g is clicked, to the working table 31.

The phrase is added as the lower layer of the original sentence of the original phrase displayed in the original sentence display box 21b.

In addition, the “translated sentence” field of the new record becomes blank.

In the next step S122, the CPU 10c executes a process to replace the displayed contents in the original sentence display box 21b with the phrase that is chosen at the time when the lower-layer-making button 23g is clicked.

In the next step S123, the CPU 10c executes a process to add and display an item showing the phrase in the chosen portion in the layer display box 21d.

In addition, FIG. 12 shows one example of the working window 21 when some items are displayed in the layer display box 21d. As shown in FIG. 12, the respective items are displayed with layered structure depending on the inclusion relation among them in the layer display box 21d.

After displaying the items showing the phrase in the chosen portion in the layer display box 21d, the CPU 10c returns the process from step S123 to step S100 and waits until an event occurs.

On the other hand, when the event occurs in step S100 is not a click of the lower-layer-making button 21g (S102, No), the CPU 10c proceeds the process from step S102 to step S103.

In step S103, the CPU 10c determines whether the event is a choice of any one of items displayed in the layer display box 21d or not.

And then, when the event occurred in step S100 is a choice of any one of items displayed in the layer display box 21d, the CPU 10c branches the process from step S103 to step S131.

In step S131, the CPU 10c executes a process to replace the displayed contents in the original sentence display box 21b with the original sentence or the original phrase shown by the item that is chosen from the items in the layer display box 21. Further, when the translated sentence or the translated phrase corresponding to the original sentence or the original phrase of the item is included in the working table 31, the CPU 10c executes a process to replace the displayed contents in the translation display box 21c with the translated sentence or the translated phrase. However, if the translated sentence or the translated phrase corresponding the sentence of the item is not included in the working table 31, the CPU 10c blanks the translation display box 21c.

In the next step S132, the CPU 10c determines whether a lower layer is established within the original sentence or the original phrase of the chosen item or not with reference to the working table 31.

And then, when the lower layer is established within the original sentence or the original phrase of the chosen item, the CPU 10c proceeds the process from step S132 to step S133.

In step S133, the CPU 10c executes a process to highlight the portion of the next-lower layer in the original sentence or original phrase displayed in the original sentence display box 21b. Further, when the translated sentence or the translated phrase is displayed in the translation display box 21c, the CPU 10c executes a process to highlight the portion of the next-lower layer in the translated sentence or the translated phrase. In addition, if there are a plurality of next-lower layer portions that should be highlighted in the phrases in the original sentence display box 21b and the translation display box 21c, the CPU 10c may highlight the next-lower layer portions in different colors, respectively, or may highlight them in the same color, the same background color and the same font.

And then, after highlighting the next-lower layer portions, the CPU 10c returns the process from step S133 to step S100, and waits until an event occurs.

Further, when a lower layer is not established in the original sentence or the original phrase shown by the item chosen from the items in the layer display box 21d, the CPU 10c branches the process from step S132 to step S100 without highlighting a next-lower layer portion, and waits until an event occurs.

In addition, the CPU 10c that executes the process from step S131 to step S133 corresponds to the displaying means described above.

On the other hand, when the event occurred in step S100 is not a choice of any one of items in the layer display box 21d (S103, No), the CPU 10c proceeds the process from step S103 to step S104.

In step S104, the CPU 10c determines whether the event occurred in step S100 is a locking/unlocking operation for any one of items in the layer display box 21d or not. As shown in FIG. 12, an item in the layer display box 21d includes a button 211 that displays either a symbol “◯” or a symbol “▴”. Clicking the button 211 toggles the symbol “◯” and the symbol “▴”. The button 211 is used for the locking/unlocking operation described above. The symbol “◯” represents a locked state and the symbol “▴” represents an unlocked state.

If the event occurred in step S100 is the locking/unlocking operation (a click of the button 211) for any one of items in the layer display box 21d, the CPU 10c branches the process from step S104 to step S141.

In step S141, the CPU 10c determines whether the value in the “lock flag” field corresponding to the unit of the item in the working table 31 of FIG. 11 is “1 (locked)” or “0 (unlocked)”.

Then, when the value in the “lock flag” field corresponding to the unit of the item in the working table 31 of FIG. 11 is “1 (locked)”, the CPU 10c proceeds the process from step S141 to step S142.

In step S142, the CPU 10c executes a process to switch the value in the “lock flag” field corresponding to the unit of the item in the working table 31 from “1 (locked)” to “0 (unlocked)”.

In the next step S143, the CPU 10c determines whether there is a unit in an upper layer including the unit of the item or not with reference to the working table 31 in FIG. 11.

When there is a unit in an upper layer including the unit of the item, the CPU 10c proceeds the process from step S143 to step S144.

In step S144, the CPU 10c executes a process to switch the value in the “lock flag” field of the units, which belong to the upper layer including the unit of the item and take the value “1 (locked)” in the “lock flag” field in the working table 31 in FIG. 11, from “1 (locked)” to “0 (unlocked)”.

After executing such an unlocking process, the CPU 10c returns the process from step S144 to step S100, and waits until an event occurs.

In step S143, if there is no unit in an upper layer including the unit of the item, the CPU 10c branches the process from step S143 to step S100 without executing the unlocking process, and waits until an event occurs.

In step S141, if the value in the “lock flag” field of the record corresponding to the unit of the item in the working table 31 in FIG. 11 is “0 (unlocked)”, the CPU 10c branches the process from step S141 to step S145.

In step S145, the CPU 10c executes a process to switch the value in the “lock flag” field of the record corresponding to the unit of the item in the working table 31 from “0 (unlocked)” to “1 (locked)”.

In the next step S146, the CPU 10c determines whether there is a unit in a lower layer included in the unit of the item or not with reference to the working table 31 in FIG. 11.

When there is a unit in a lower layer included in the unit of the item, the CPU 10c proceeds the process from step S146 to step S147.

In step S147, the CPU 10c executes a process to switch the value in the “lock flag” field of the units, which belong to the lower layer included in the unit of the item and take the value “0 (unlocked)” in the “lock flag” field in the working table 31 in FIG. 11, from “0 (unlocked)” to “1 (locked)”.

After executing such a locking process, the CPU 10c returns the process from step S147 to step S100, and waits until an event occurs.

In step S146, if there is no unit in a lower layer included in the unit of the item, the CPU 10c branches the process from step S146 to step S100 without executing the locking process, and waits until an event occurs.

In addition, the CPU 10c that executes the process from step S141 to step S146 corresponds to a locking/unlocking means.

On the other hand, when the event occurred in step S100 is not a locking/unlocking operation (a click of the button 211) for any one of items in the layer display box 21d (S104, No), the CPU 10c proceeds the process from step S104 to step S105.

In step S105, the CPU 10c determines whether the event occurred in step S100 is a click of the module change button 21h or not.

If the event occurred in step S100 is a click of the module change button 21h, the CPU 10c branches the process from step S105 to step S151.

In step S151, the CPU 10c determines whether the translation process is assigned to the machine translation module 12a or to the translation-memory-retrieval module 12c.

When the translation process is assigned to the machine translation module 12a, the CPU 10c proceeds the process from step S151 to step S152.

In step S152, the CPU 10c executes a process to switch the translation module to the translation-memory-retrieval module 12c, returns the process from step S152 to step S100, and waits until an event occurs.

When the translation process is assigned to the translation-memory-retrieval module 12c, the CPU 10c proceeds the process from step S151 to step S153.

In step S153, the CPU 10c executes a process to switch the translation module to the machine translation module 12a, returns the process from step S153 to step S100, and waits until an event occurs.

On the other hand, if the event occurred in step S100 is not a click of the module change button 21h (S105, No), the CPU 10c proceeds the process from step S105 to step S106.

In step S106, the CPU 10c determines whether the event occurred in step S100 is a click of the assembling button 21i or not.

When the event occurred in step S100 is a click of the assembling button 21i, the CPU 10c proceeds the process from step S106 to step S161.

In step S161, the CPU 10c determines whether the value of the “lock flag” field of the record including the original sentence or the original phrase, which is displayed in the original sentence display box 21b when the assembling button 21i is clicked, among the records in the working table 31 in FIG. 11 is “0 (unlocked)” or not.

When the value of the “lock flag” field of the record including the original sentence or the original phrase, which is displayed in the original sentence display box 21b when the assembling button 21i is clicked, is “1 (locked)”, the CPU 10c branches the process from step S161 to step S100, and waits until an event occurs.

Further, when the value of the “lock flag” field of the record including the original sentence or the original phrase, which is displayed in the original sentence display box 21b when the assembling button 21i is clicked, is “0 (unlocked)”, the CPU 10c proceeds the process from step S161 to step S162.

In step S162, the CPU 10c determines whether there is a unit in a lower layer having a part of the original sentence or the original phrase that is displayed in the original sentence display box 21b when the assembling button 21i is clicked or not with reference to the working table 31 is FIG. 11.

And if there is no unit in a lower layer having a part of the original sentence or the original phrase that is displayed in the original sentence display box 21b when the assembling button 21i is clicked, the CPU 10c proceeds the process from step S162 to step S163.

In step S163, the CPU 10c makes the translation module assigned at the time translate the original sentence or the original phrase displayed in the original sentence display box 21b when the assembling button 21i is clicked. The machine translation module 12a translates a target phrase automatically, while the translation-memory-retrieval module 12c retrieves a sentence or a phrase that is identical to or similar to a target sentence or a target phrase and outputs a sentence or a phrase in the other language corresponding to the retrieved sentence or phrase as a translation result.

In addition, the CPU 10c that executes the process in step S163 corresponds to a translation-memory-retrieval means.

In next step S164, the CPU 10c determines whether the translation result (a translated sentence or a translated phrase) generated in step S163 contains a variable or not. In this embodiment, when a target sentence or phrase is translated by the translation-memory-retrieval module 12c, the translation result may contain the variable. The translation result that contains a variable will be described hereinafter.

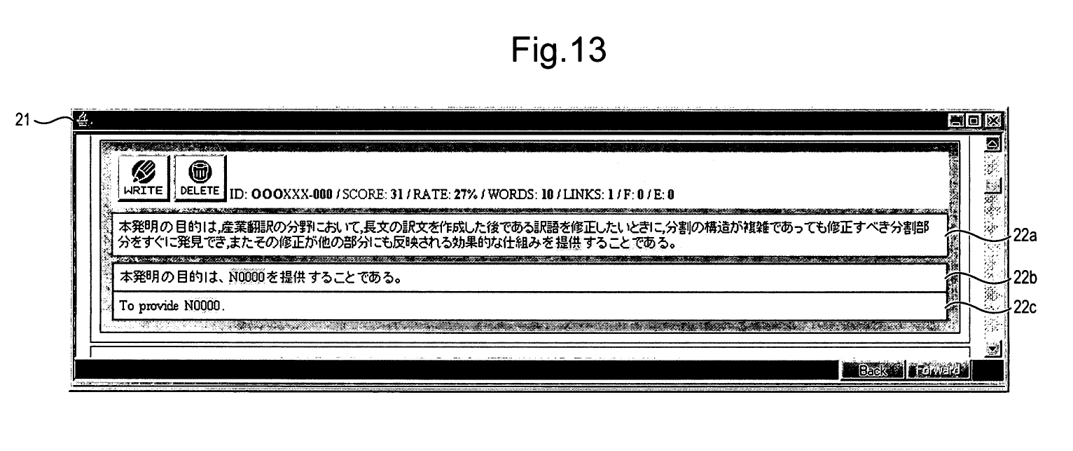

FIG. 13 shows a retrieval result when the translation-memory-retrieval module 12c translates a sentence (the translation example retrieval).

In FIG. 13, a target sentence to be translated is shown in an upper box 22a. Further, a sentence that is retrieved from the translation example database 12d as the identical or similar sentence to the target sentence is shown in a middle box 22b. Still further, a translated sentence that corresponds to the sentence in the middle box 22b in the translation example database 12d is shown in a lower box 22c. As shown in FIG. 13, the translated sentence in the middle box 22b and the translated sentence in the lower box 22c contain the variable “N0000” at the positions of the same contents. Such a sentence and a translated sentence are registered as a form of pair in the translation example database 12d.

When the translation result (the translated sentence or the translated phrase) generated in step S163 does not contain a variable (S164, Yes), the CPU 10c proceeds the process from step S164 to step S165.

In step S165, the CPU 10c executes a process to store the translated sentence or the translated phrase generated in step S163 into the “translated sentence” field of the record that includes the original sentence or the original phrase displayed in the original sentence display box 21b when the assembling button 21i is clicked among the records in the working table 31 in FIG. 11, and to store the attribute information (machine or translation example) corresponding to the translation module into the “attribute” field of the record.

In addition, the CPU 10c that executes the process in step S303 corresponds to the translation result output means.

The CPU 10c proceeds the process from step S165 to step S169 after recording the translated sentence or the translated phrase and the attribute information to the working table 31.

When the translation result (the translated sentence or the translated phrase) generated in step S163 does not contain a variable (S164, Yes), the CPU 10c branches the process from step S164 to step S166.

In step S166, the CPU 10c executes a layer generating process as a subroutine.

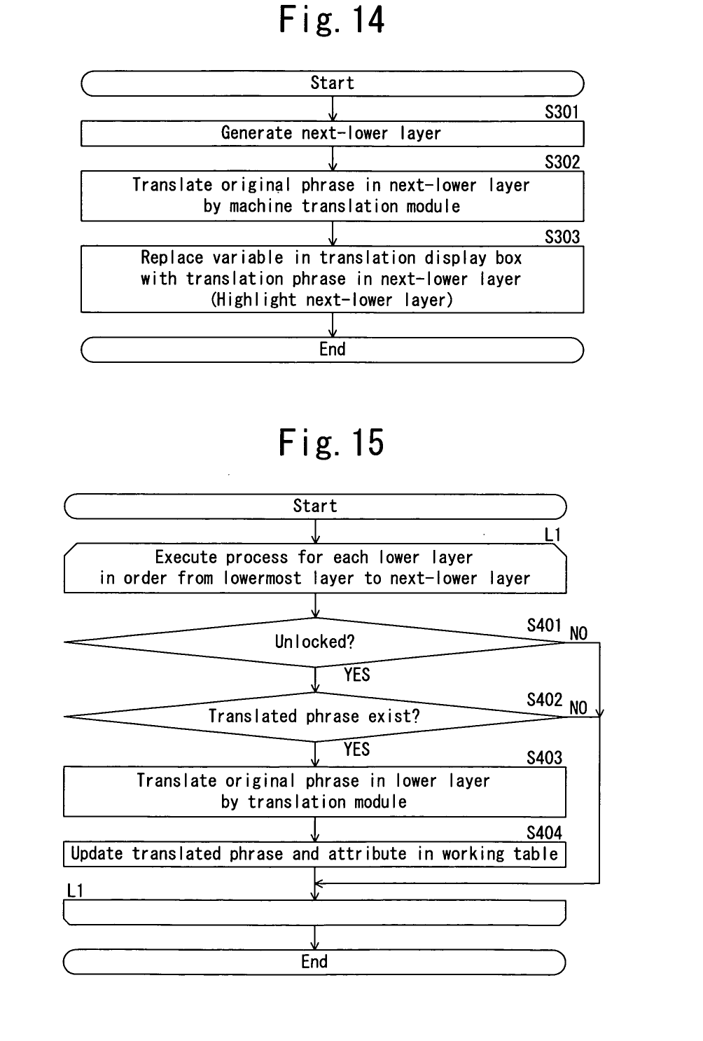

FIG. 14 is a flowchart showing the layer generation process.

In the first step S301 of the layer generation process, the CPU 10c compares the sentence or the phrase retrieved by the translation-memory-retrieval module 12c as to be identical to or similar to the original sentence or the original phrase in the original sentence display box 21b at step S163 with the original sentence or the original phrase to be translated, and additionally registers the phrase corresponding to a variable part in the original sentence or the original phrase to be translated into the working table 31 in FIG. 11 as the next-lower layer.

In addition, the CPU 10c that executes the process in step S301 corresponds to a layer generating means.

In the next step S302, the CPU 10c executes a process to make the machine translation module 12a translate the original phrase in the next-lower layer generated in step S301. Further, the CPU 10c executes a process to store the translation result into the “translated sentence” field of the record of the unit in the next-lower layer in the working table 31.

In addition, the CPU 10c that executes the process in step S302 corresponds to a next-lower layer translating means.

In the next step S303, the CPU 10c executes a process to replace the variable in the translation result generated in step S163 with the translation result generated in step S302, and to update the displayed contents in the translation display box 21c.

Further, the CPU 10c executes a process to highlight the replaced portion (that is, the unit in the next-lower layer) in the translation display box 21c. After that, the CPU 10c finishes the layer generation process and proceeds the process to step S169 in FIG. 7.

In addition, the CPU 10c that executes the process of step S303 corresponds to a translation example registering means.

If there is a lower layer including a pair of the original sentence or the original phrase displayed in the original sentence display box 21b when the assembling button 21i is clicked, the CPU 10c branches the process from step S162 to step S167.

In step S167, the CPU 10c executes a lower layer translation process as a subroutine.

FIG. 15 is a flowchart showing a flow of the lower layer translation process.

In the lower layer translation process, the CPU 10c executes a process loop L1. In the process loop L1, the CPU 10c executes process from step S401 to step S404 for respective units in all the lower layers. At the time, the CPU 10c executes process from step S401 to step S404 in order from the lowermost layer to the next-lower layer.

In step S401, the CPU 10c determines whether the unit of the lower layer of the process target of the process loop L1 is locked or not with reference to the working table 31 in FIG. 11.

When the unit in the lower layer of the process target is locked, the CPU 10c finishes the process from step S401 to step S404 with respect to the current process target.

On the other hand, when the unit in the lower layer of the process target is not locked, the CPU 10c proceeds the process from step S401 to step S402.

In step S402, the CPU 10c determines whether a translated phrase is stored in the “translated sentence” field of the unit in the lower layer of the process target or not with reference to the working table 31 in FIG. 11.

When a translated phrase is not stored in the “translated sentence” field of the unit in the lower layer of the process target, the CPU 10c finishes the process from step 401 to step S404 with respect to the current process target.

On the other hand, when a translated phrase is stored in the “translated sentence” field of the unit in the lower layer of the process target, the CPU 10c proceeds the process from step S402 to step S403.

In step S403, the CPU 10c executes a process to make the translation-memory-retrieval module 12c translate the original phrase of the unit in the lower layer of the process target. Further, when the translation-memory-retrieval module 12c cannot translate the original phrase, the CPU 10c makes the machine translation module 12a translate it. At the time, when the lower layer of the process target has a next-lower layer, the CPU 10c combines the translated phrases in the next-lower layer into one block and incorporates the block into the translated phrase in the lower layer of the process target.

In step S404, the CPU 10c executes a process to replace the value in the “translated sentence” field of the record corresponding to the unit in the lower layer of the process target in the working table 31 in FIG. 11 with the translated phrase generated in step S167. At the time of replacement, the CPU 10c also executes a process to update the value in the “attribute” field of the record according to the attribute information (machine or translation example) of the translation module.

In addition, the CPU 10c that executes the process in step S404 corresponds to a saving means.

After generating the translated phrases for all the lower layers that include a part of the original sentence or the original phrase displayed in the original sentence display box 21b when the assembling button 21i is clicked, the CPU 10c leaves the process loop L1, finishes the lower layer translation process in FIG. 15, and proceeds the process to step S168 in FIG. 7.

In step S168, the CPU 10c makes the translation module translate the original sentence or the original phrase that is displayed in the original sentence display box 21b when the assembling button 21i is clicked with incorporating the translated phrases in the next-lower layer. Next, the CPU 10c executes a process to display the translated sentence or the translated phrase obtained by the translation in the translation display box 21c. Furthermore, the CPU 10c executes a process to highlight the unit in the next-lower layer in the translation display box 21c. Then, the CPU 10c proceeds the process to step S169.

As described above, when a unit in a lower layer is established for the original sentence or the original phrase displayed in the original sentence display box 21b, a translation of the original sentence or the original phrase in the original sentence display box 21b can be generated by translating in order from the lowermost layer (step S162, No, L1, step S168). Further, when a lower layer is not established for the original sentence or the original phrase displayed in the original sentence display box 21b but the translation result contains a variable, since the portion of the variable is set as a lower layer, a translation of the original sentence or the original phrase in the original sentence display box 21b can be generated after the unit of the lower layer is translated (step S162, YES, S163, S164, No, S166).

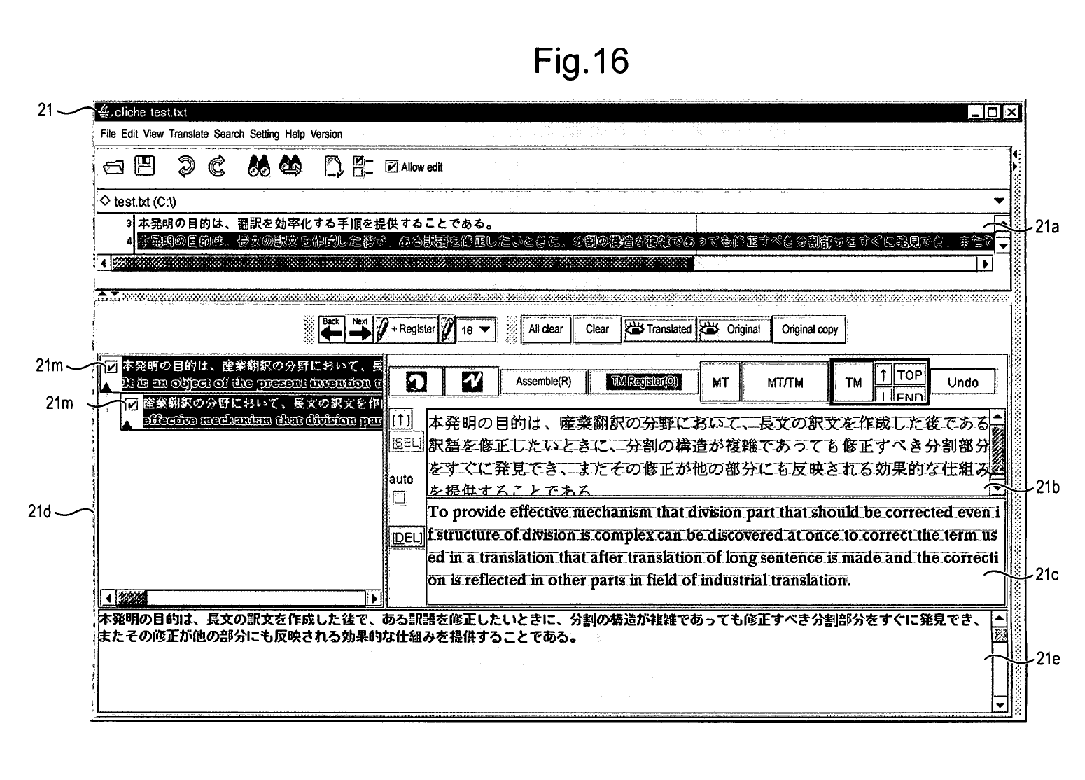

In step S169, the CPU 10c executes a process to replace the translated sentence or the translated phrase registered in the working table 31 corresponding to the sentence that is displayed in the original sentence display box 21b when the assembling button 21i is clicked with the translated sentence or the translated phrase displayed in the translation display box 21c. At the time of replacement, the CPU 10c also executes a process to update the value in the “attribute” field of the same record for the translated sentence or the translated phrase according to the attribute information (machine or translation example) of the translation module. FIG. 16 shows the working window 21 where the translation result shown in FIG. 13 is displayed by executing the lower layer translation process in FIG. 15 and step S168.

After updating the working table 31, the CPU 10c returns the process from step S169 to step S100, and waits until an event occurs.

On the other hand, when the event occurred in step S100 is not a click of the assembling button 21i (S106, No), the CPU 10c proceeds the process from step S106 to step S107.

In step S107, the CPU 10c determines whether the event occurred in step S100 is a click of the translation-memory-registration button 21j or not.

When the event occurred in step S100 is a click of the translation-memory-registration button 21j, the CPU 10c branches the process from step S107 to step S171.

In step S171, the CPU 10c reads an original sentence and a translated sentence of an uppermost layer from the working table 31 in FIG. 11, and adds a record that includes the original sentence and the translated sentence to the translation example database 12d.

In the next step S172, the CPU 10c determines whether the original sentence in the uppermost layer that is registered to the translation example database 12d in step S171 has a lower layer or not with reference to the working table 31. In addition, the CPU 10c that executes the process in step S172 corresponds to a determining means.

When the original sentence in the uppermost layer that is registered to the translation example database 12d in step S171 does not have a lower layer, the CPU 10c returns the process from step S172 to step S100, and waits until an event occurs.

When the original sentence in the uppermost layer that is registered to the translation example database 12d in step S171 has a lower layer, the CPU 10c proceeds the process from step S172 to step S173.

In step S173, the CPU 10c executes a process to replace the next-lower layer of the original sentence and the translated sentence in the uppermost layer with a variable. At the time, the CPU 10c uses the same variable for the original sentence and the translated sentence in the same manner as the translation result shown in FIG. 13. The CPU 10c executes a process to add the record that includes the original and translated sentences of which parts are replaced by the variable in the uppermost layer to the translation example database 12d. After adding the record to the translation example database 12d, the CPU 10c proceeds the process to step S174.

In step S174, the CPU 10c specifies the next-lower layer of the uppermost layer as a process target and proceeds the process to step S175.

In step S175, the CPU 10c determines whether the process target is designated as a registration target or not. The registration target is designated by choosing an original sentence or an original phrase and a translated sentence or a translated phrase among the respective items in the layer display box 21d as items to be registered into the translation example database 12d. Specifically, as shown in FIG. 12 and FIG. 16, each item in the layer display box 21d includes a check box 21m. When a check mark is input into a check box 21m, the item is chosen as an item to be registered into the translation example database 12d. An original sentence or an original phrase and a translated sentence or a translated phrase of the chosen item are registered. In other words, the step S177 is a process to determine whether a check mark is input or not in a check box of an item that includes an original sentence or an original phrase of the process target and a translated sentence or a translated phrase.

When a process target is designated as a registration target, the CPU 10c proceeds the process from step S175 to step S176.

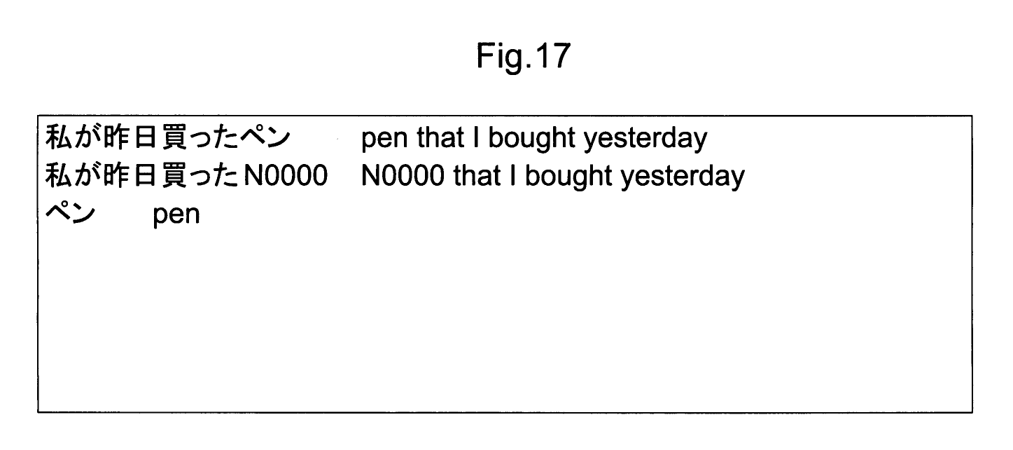

In step S176, the CPU 10c executes a process to add the record that includes the original phrase and the translated phrase in the layer of the process target to the translation example database 12d. FIG. 17 shows one example of the data structure of the translation example database 12d that stores original sentences and translated sentences with variables. In the translation example database 12d, a pair of an original sentence and a translated sentence is listed in each line. After adding a record to the translation example database 12d, the CPU 10c proceeds the process to step S177.

In addition, the CPU 10c that executes the process in step S176 corresponds to a registering means.

When no process target is designated as a registration target is not designated (S175, No), the CPU 10c proceeds the process from step S175 to step S177.

In step S177, the CPU 10c determines whether the original phrase and the translated phrase in the layer of the process target have a layer of the same level or a lower level. In addition, the CPU 10c that executes the process in step S177 corresponds to the determining means.

When the original phrase and the translated phrase in the layer of the process target have a layer of the same level or a lower level, the CPU 10c proceeds the process from step S177 to step S178.

In step S178, the CPU 10c executes a process to replace the portion of the next-lower layer of the original phrase and the translated phrase in the layer of the process target with a variable. Further, the CPU 10c executes a process to add the record that includes the original and translated sentences of which parts are replaced by the variable in the uppermost layer to the translation example database 12d. After adding the record to the translation example database 12d, the CPU 10c proceeds the process to step S179.

In addition, the CPU 10c that executes the process in step S178 corresponds to the registering means.

In step S179, the CPU 10c specifies the layer whose level is identical to or lower than the layer of the process target as a new process target, and then, returns the process to step S175 and determines whether the new process target is designated as a registration target or not.

Further, when the original phrase and the translated phrase in the layer of the process target do not have a layer of the same level or a lower level, the CPU 10c branches the process from step S177 to step S100, and waits until an event occurs.

On the other hand, when the event occurred in step S100 is not a click of the translation-memory-registration button 21j, the CPU 10c proceeds the process from step S107 to step S108.

In step S108, the CPU 10c determines whether the event occurred in step S100 is a correction to the translated sentence displayed in the translation display box 21c or not.

When the event occurred in step S100 is a correction to the translated sentence displayed in the translation display box 21c, the CPU 10c branches the process from step S108 to step S181.

In step S181, the CPU 10c determines whether the correction of the translated sentence in the translation display box 21c is an input of an embedded symbol or not. The embedded symbol is used, when a next-lower layer is established to the original sentence or the original phrase in the original sentence display box 21b, to input a translated sentence in the next-lower layer into the translation display box 21c automatically without key entry.

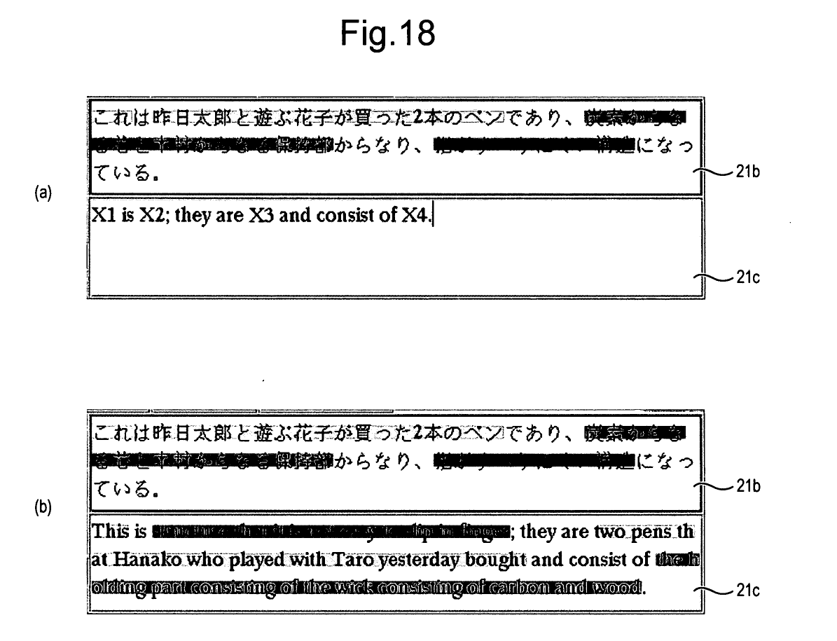

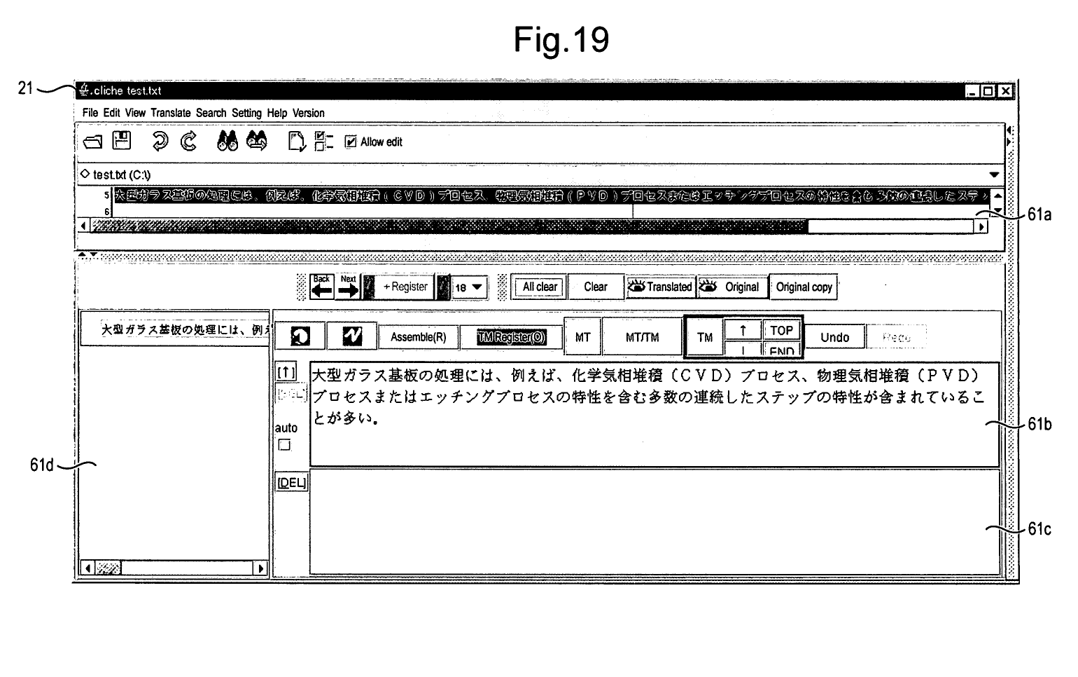

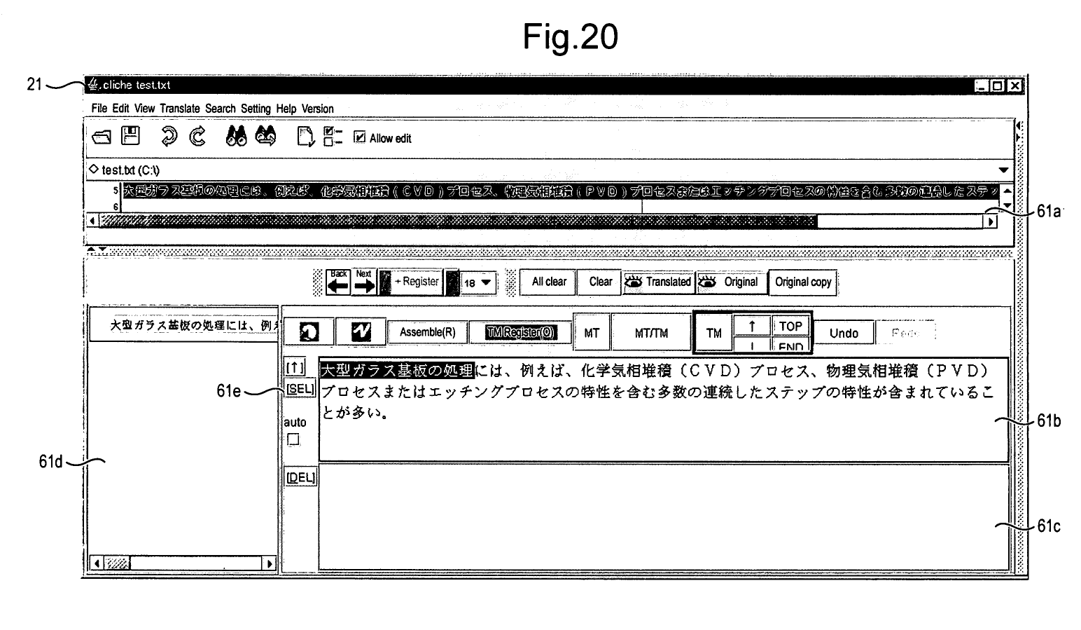

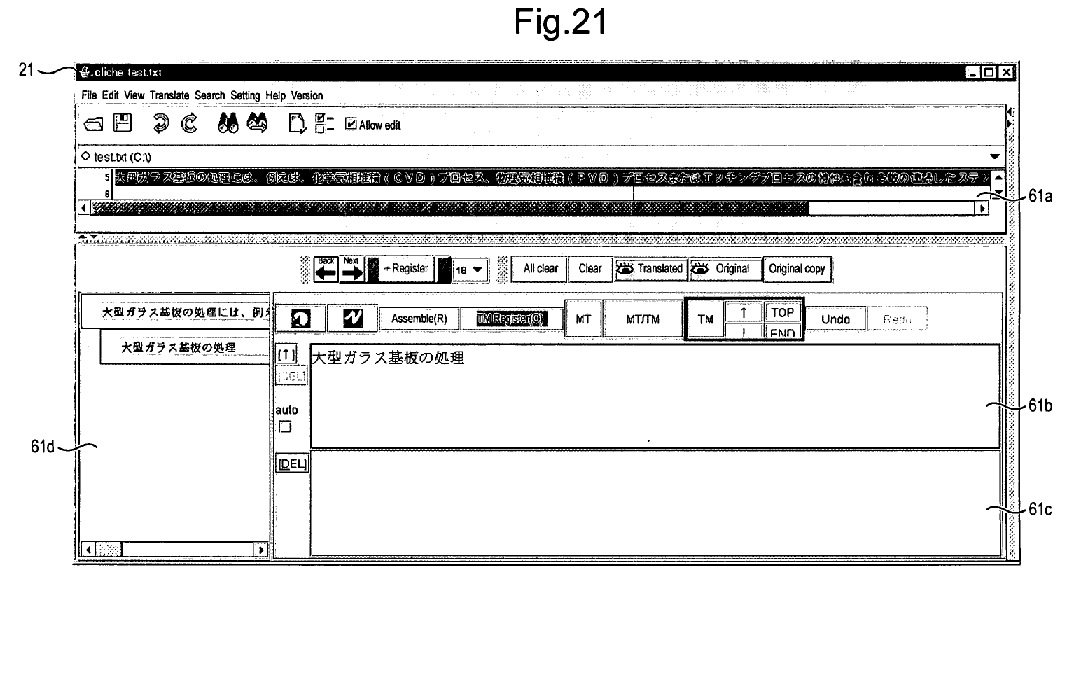

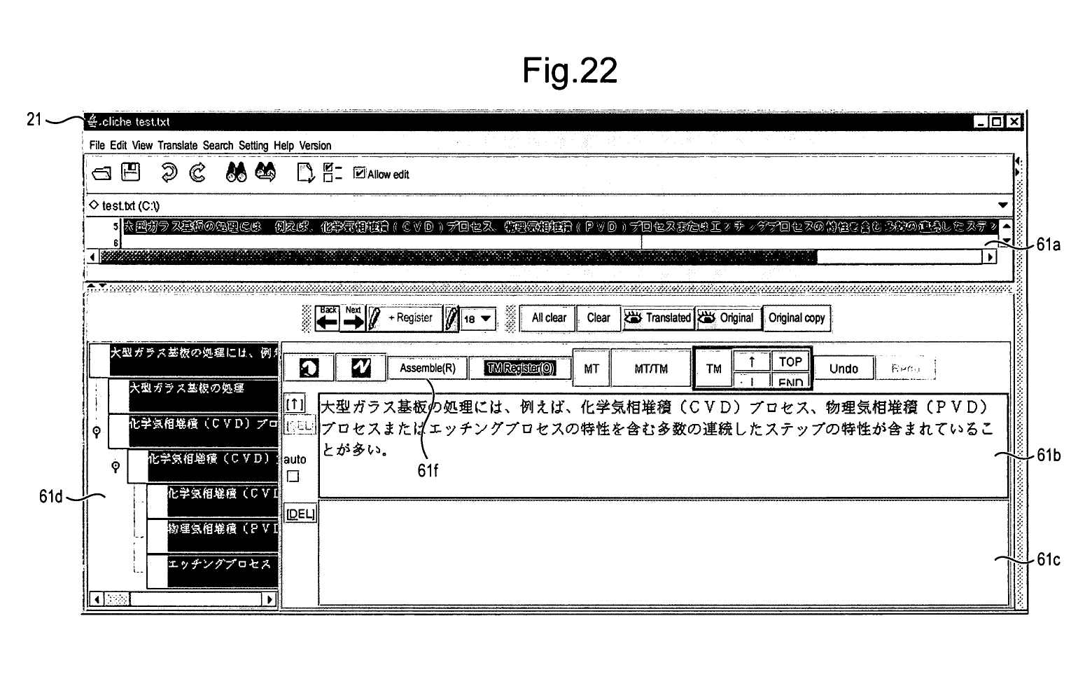

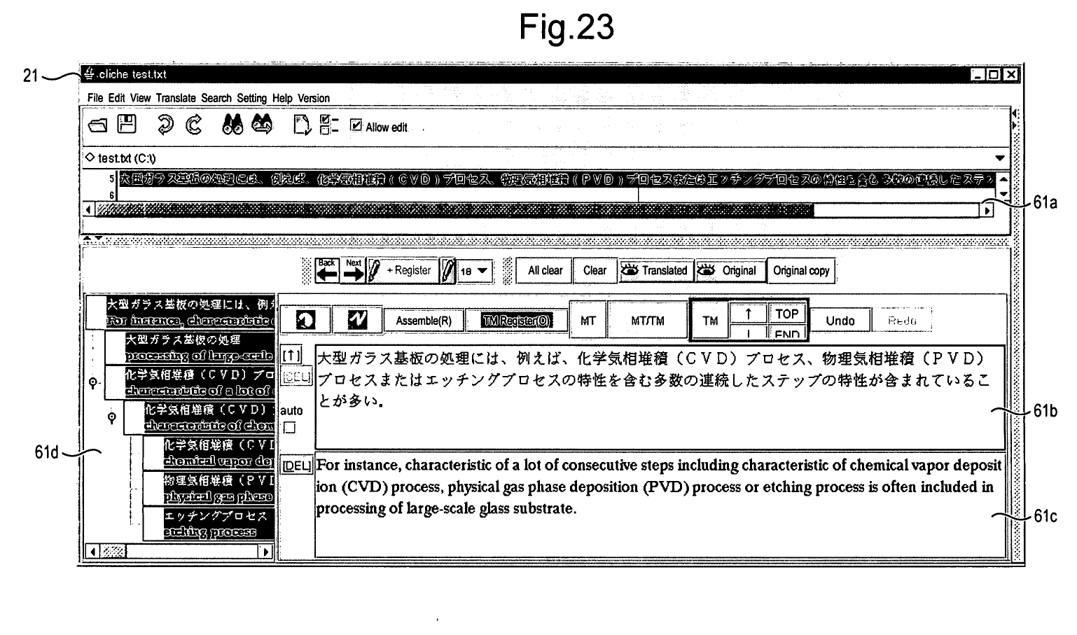

FIG. 18 is used to describe the embedded symbol specifically.

When an operator inputs the embedded symbols (X1 . . . X4) in a translated sentence in the translation display box 21c as shown in FIG. 18A, the translated phrases in the next-lower layer corresponding to the embedded symbols are automatically incorporated at the positions of the symbols as shown in FIG. 18B. When a plurality of next-lower layers are established for an original sentence or an original phrase displayed in the original sentence display box 21b, ordinal numbers of the respective next-lower layers from the beginning are defined in the respective embedded symbols. Therefore, when an operator would like to input a translated phrase of a second next-lower layer from the beginning of a sentence into the translation display box 21c, he or she should choose the embedded symbol that means the second next-lower layer (X2 in FIG. 18A) among many embedded symbols and input into the translation display box 21c.

When the correction of the translated sentence in the translation display box 21c is an input of the embedded symbol, the CPU 10c proceeds the process from step S181 to step S182.

In step S182, the CPU 10c reads a translated phrase in the next-lower layer whose order is defined in the embedded symbol from the working table 31 among the next-lower layers established to the original sentence or the original phrase in the original sentence display box 21b.

In the next step S183, the CPU 10c executes a process to replace the current embedded symbol in the translation display box 21d with the translated phrase read in step S182. The, the CPU 10c proceeds the process to step S185.

In addition, the CPU 10c that executes the process from step S181 to step S183 corresponds to a replacing means.

When the correction of the translated sentence in the translation display box 21c is not an input of an embedded symbol, the CPU 10c branches the process from step S181 to step S184.

In step S184, the CPU 10c determines whether a cursor in the translation display box 21c before the correction was positioned within the range of the lower layer that is established to the sentence in the original sentence display box 21b or not.

When the cursor in the translation display box 21c before the correction was not positioned within the range of the lower layer that is established to the sentence in the original sentence display box 21b, the CPU 10a proceeds the process from step S184 to step S185.

In step S185, the CPU 10c executes a process to replace the value in the “translated sentence” field of the record that includes the original sentence or the original phrase in the original sentence display box 21b in the working table 31 in FIG. 11 with the translated phrase displayed in the translation display box 21c. In addition, the CPU 10c executes a process to overwrite the value of the “attribute” field of the current record with the attribute information (edit).

The CPU 10c returns the process from step S185 to step S100 after reflecting the current edit, and waits until an event occurs.

When the cursor in the translation display box 21c before the correction was positioned within the range of the lower layer that is established to the sentence in the original sentence display box 21b, the CPU 10c proceeds the process from step S184 to step S186.

In step S186, the CPU 10c determines whether the unit of the lowermost layer among the lower layers including the cursor position before the correction is unlocked or not with reference to the working table 31 in FIG. 11.

When the unit of the lowermost layer among the lower layers including the cursor position before the correction is locked, the CPU 10c returns the process from step S186 to step S100, and waits until an event occurs.

When the unit of the lowermost layer among the lower layers including the cursor position before the correction is unlocked, the CPU 10c proceeds the process from step S186 to step S187.

In step S187, the CPU 10c executes a process to reflect the correction to the value (translated phrase) in the “translated sentence” field of the record of the unit in the lowermost layer in the working table 31 in FIG. 11. Further, the CPU 10c executes a process to overwrite the value of the “attribute” field of the current record with the attribute information (edit).

In the next step S187′, when the parallel translation data 14 stores a record whose “original sentence” field contains the same original phrase as that in the lowermost layer, the CPU 10c executes a process to reflect the current correction to the value (original phrase) of the “original sentence” field of the record.

Then, the CPU 10c proceeds the process from step S187′ to step S188 after reflecting the correction to all the sentences in the parallel translation data 14.

In step S188, the CPU 10c determines whether there is a next-upper layer of the current layer or not.

When there is a next-upper layer of the current layer, the CPU 10c proceeds the process from step S188 to step S189.

In step S189, the CPU 10c executes a process to replace the part of the current layer in the value (translated phrase) of the “translated sentence” field of the record in the next-upper layer of the process target with the translated phrase of the current layer in the working table 31 in FIG. 11.

In the next step S190, the CPU 10c specifies a next-upper layer of the current layer as a new process target. After specifying, the CPU 10c returns the process to step S188, and executes a process to determine whether there is a next-upper layer of the layer of the new process target or not.

In addition, the CPU 10c that executes the process of step S184 corresponds to a detecting means. Further, the CJPU 10c that executes the process from step S186 to step S190 corresponds to the propagating means.

If there is not a next-upper layer of the current layer, the CPU 10c branches the process from step S188 to step S100, and waits until an event occurs.

On the other hand, if the event occurred in step S100 is not a correction to the translated sentence displayed in the translation display box 21c, the CPU 10c proceeds the process from step S108 to step S109.

In step S109, the CPU 10c determines whether the event occurred in step S100 is a click of the translation verifying button 21k or not.

When the event occurred in step S100 is a click of the translation verifying button 21k, the CPU 10c branches the process from step S109 to step S191.

In step S191, the CPU 10c executes a process to make the translation-memory-retrieval module 12c translate an original sentence or an original phrase displayed in the original sentence display box 21b. If the translation-memory-retrieval module 12c cannot obtain a translation result, the CPU 10c executes a process to make the n machine translation module 12a translate it. In addition, the CPU 10c that executes the process in step S191 corresponds to a translating means.

In the next step S192, the CPU 10c executes a process to compare a translated sentence or a translated phrase displayed in the translation display box 21c with a translation result generated in step S191 to extract a different portion. This process may be executed using one function of the translation-memory-retrieval module 12c. Alternatively, a well-known function comparing sentences may be used. The CPU 10c that executes the process in step S192 corresponds to a difference extracting means.

In the next step S193, the CPU 10c executes a process to change the background color of the different portion extracted in step S192 within the sentence (a translated sentence or the translated phrase) displayed in the translation display box 21c so as to be different from the ground color. After execution of this process, the CPU 10c returns the process from step S193 to step S100, and waits until an event occurs.

In addition, the CPU 10c that executes the process in step S193 corresponds to a difference highlighting means.

On the other hand, if the event occurred in step S100 is not a click of the translation verifying button 21k, the CPU 10c proceeds the process from step S109 to step S110.

In step S110, the CPU 10c determines whether the event occurred in step S100 is an end instruction or not.

When the event occurred in step S100 is not the end instruction, the CPU 10c branches the process from step S110 to step S200.

In step S200, the CPU 10c executes a process appropriate to the event, returns the process to step S100, and waits until an event occurs.

On the other hand, if the event occurred in step S100 is the end instruction, the CPU 10c finishes the translator support process in FIG. 2 through FIG. 11.

Next, functions and effects of the translator support device 10 will be described.

When an operator of the translator support device 10 operates the input device 10b to specify the parallel translation data 14, the working window 21 of FIG. 10 is displayed on the display device 10a, and sentences are displayed one by one on each of lines in the sentence list box 21a.

When the operator puts the cursor on one of lines in the sentence list box 21a, the information about the sentence on the line that is registered in the parallel translation data 14 is displayed in the original sentence display box 21b, the translation display box 21c, and the layer display box 21d.

For example, the translated sentence “This is the pen I bought yesterday” in the uppermost layer in the working table 31 in FIG. 11 is displayed in the translation display box 21c. When an operator puts a cursor on a position of “t” of “the” in the translation display box 21c, the “t” is eliminated. With reference to the “next-upper layer” field and the “length” field in the working table 31 in FIG. 11, it is realized that the unit of the lowermost layer including the cursor position is “the pen” (step S184, Yes). Therefore, the translated phrase “the pen” in the layer is corrected to be “he pen” (step S187). Further, the translated phrase “the pen I bought yesterday” in the next-upper layer is corrected to “he pen I bought yesterday”, and the translated sentence “This is the pen I bought yesterday” in the uppermost layer is corrected to “This is he pen I bought yesterday” (steps S188 through S190).

Still further, it is assumed that the translated sentence “This is the pen I bought yesterday” is displayed in the translation display box 21c and that an operator puts a cursor at a “n” position of “pen” and adds “s”. With reference to the working table 31 in FIG. 11, it is realized that the unit in the lowermost layer including the cursor position is “the pen” (S184, Yes). Therefore, the translated phrase “the pen” in the layer is corrected to “the pens” (step S187). Yet further, the translated phrase “the pen I bought yesterday” in the next-upper layer is corrected to “the pens I bought yesterday”, and the translated sentence “This is the pen I bought yesterday” in the uppermost layer is corrected to “This is the pens I bought yesterday” (step S188 through step S190).

In addition, assuming that the translated sentence “This is the pen I bought yesterday” is displayed in the translation display box 21c and an operator puts a cursor on a blank between “is” and “the”, and adds “n”. With reference to the working table 31 in FIG. 11, it is realized that the unit in the lowermost layer including the cursor position is “This is the pen I bought yesterday” (step S184, No). Therefore, the translated phrase “This is the pen I bought yesterday” in the layer is corrected to “This is nthe pen I bought yesterday” (step S187). At the time, “n” is not added to the layers of “the pen” and “the pen I bought yesterday” (step S188; NO). Furthermore, when the operator inputs “o” and “t” in this order at the current cursor position, the translated phrase “This is nthe pen I bought yesterday” in the current layer is corrected to “This is not the pen I bought yesterday”.

As described above, according to the translator support device 10 of the embodiment, when the translated phrase in the translation display box 21c is corrected, units in layers that include the corrected portion are retrieved, and the correction can be reflected to the units in all the layers including the lowermost layer.

Further, according to the embodiment, an operator can protect any translated phrases so as not to be changed by operating the locking/unlocking button 211 assigned to each of items displayed in the layer display box 21d. As a result, an operator can be prevented from starting reorganization collection by mistake about the item that completed translation (step S145). Furthermore, when any item is locked, all the lower layers are also locked (step S146, Yes, S147), which prohibits an operator from reflecting a correction for a translated phrase in the lower layer to translated phrase in the upper layer (step S186; NO). When an item is unlocked, the upper layers are also unlocked (step S142, S143, Yes, S144). Therefore, when an operator makes a correction for an upper layer of the unlocked item, the correction can be propagated from the current item to the uppermost layer (step S172, No, S173 through S179).

According to the embodiment, an operator can register an original phrase and a translated phrase without variables into the translation example database 12d (step S171). In addition, when an original phrase and a translated phrase have lower layers, an operator can register an original phrase and a translated phrase whose lower layer portions are replaced by variables into the translation example database 12d (step S172, NO, S173). Furthermore, when the lower layer has a next-lower layer, an original phrase and a translated phrase can be registered after replacing the portion of the next-lower layer of the lower layer with a variable into the translation example database 12d (step S177 through step S179). At the time, an operator can choose items to be registered into the translation example database by inputting a check mark for the check box 21m provided in each item in the layer display box 21d. Accordingly, an operator can be prevented from registering too many translation examples.

Yet further, according to the embodiment, when an operator clicks the assembling button 21i to translate an original phrase displayed in the original sentence display box 21b, a translated phrase corresponding to the original phrase is generated when the original phrase does not have a lower layer.

At the time, if the translated result contains a variable, the portion corresponding to the variable is separately registered as the next-lower layer (step S166). Therefore, an operator is not required to generate a lower layer.

When an operator clicks the assembling button 21i and if the original phrase has a lower layer, a translated phrase of the lower layer is incorporated to the translated phrase in the upper layer in order from the lowermost layer to the next-lower layer (step S167). Even if there is a non-translated layer that is not translated, the translation module generates the translated phrase of the layer and is incorporated to the translated phrase in the upper layer. In this way, since the non-translated layer is automatically translated when the assembling button 21i is clicked and the translation result is propagated to the upper layers, an operator is not required to take the trouble to translate the non-translated layer.

Still further, according to the embodiment, when an operator inputs embedded symbols to the translated phrase displayed in the translation display box 21c in response to the order of the next-lower layers, the translated phrases in the next-lower layers in response to the embedded symbols can be automatically incorporated to the translated phrase of the current layer (steps S182, S183). Therefore, an operator can omit trouble to input a translated phrase in the next-lower layers.

In addition, according to the embodiment, since portions corresponding to the next-lower layers in an original sentence or an original phrase displayed in the original sentence display box 21b are highlighted (steps S133, step S168), an operator can understand which portions correspond to the next-lower layers in the original sentence display box 21b at a glance. Since the respective portions corresponding to the next-lower layers are displayed in different colors, an operator can distinguish them easily.

In addition, according to the embodiment, since the original sentence display box 21e displays the whole original sentence (step S114), an operator can overlook the whole original sentence even if the original phrase which is one part of the original sentence is displayed in the original sentence display box 21b.

In addition, according to the embodiment, when an operator corrects a translated phrase, units that contain the same translated phrase before the correction are retrieved from the parallel translation data 14, and the correction is reflected to the translated phrases of the retrieved units (step S187′). Therefore, the operator can reflect the correction to sentences that are not chosen as translation targets in the sentence list box 21a. This function increases convenience of the translator support device 10.

In addition, according to the embodiment, when an operator clicks the translation-verifying button 21k after inputting a translated phrase into the translation display box 21c, different portions between the translated phrase corrected by the operator and the translation result generated by the translation module are displayed in the translation display box 21c (step S191 through step S193). Therefore, the operator can examine whether the translated phrase drafted by oneself is wrong or not.

What is claimed is:

1. A translator support program that operates a computer as a device comprising:
means for storing an original phrase, a translated phrase and identifying information of each of units that are established as translation units in a original sentence, and identifying information of a unit in a next-upper layer that includes said units into storage so as to be related with one another;
means for displaying an original phrase and a translated phrase of any of all units in said original sentence on a display device;
means for retrieving units, when a user's instruction to correct a translated phrase displayed on said display device by said displaying means is accepted, that includes parts to be corrected from units established in said translated phrase as lower layers; and
means for propagating the correction by repeating a process to reflect the correction to a translated phrase in each of units in all the layers retrieved by said retrieving means from the lowermost layer to the uppermost layer.

2. The translator support program according to claim 1, wherein said storing means stores an original phrase, a translated phrase, identifying information and attribute information of each of all units that are established in said original sentence, identifying information of a unit in a next-upper layer into storage so as to be related with one another; and
wherein said propagating means repeats a process to reflect the correction to a translated phrase and a process to switch the attribute information to a predetermined attribute information in each of units in all the layers retrieved by said retrieving means from the lowermost layer to the uppermost layer.

3. The translator support program according to claim 2, wherein said attribute information defines whether a correction to a translated phrase is allowed or not, and
said propagating means repeats said processes when the attribution information of the unit in the lowermost layer retrieved by said retrieving means defines that a correction is allowed.

4. The translator support program according to claim 3 that operates a computer as a device further comprising: means for locking/unlocking a unit that updates said attribute information, when a user's instruction to switch the attribute information of any unit of all units in said original sentence is accepted, of the unit that is stored in said storage to the instructed status.

5. The translator support program according to claim 1 that operates a computer as a device further comprising:
means for replacing an embedded symbol, when a user's instruction to input an embedded symbol corresponding to a unit established in a next-lower layer in the translated phrase with respect to said translated phrase displayed in said display device by said displaying means is accepted, with the translated phrase of the unit corresponding to said embedded symbol in said next-lower layer; and
means for updating the translated phrase in said storage with the replaced translated phrase.

6. The translator support program according to claim 1 wherein said displaying means displays an original phrase and a translated phrase of any unit on said display device and highlights units in the next-lower layer of said original and translated phrases.

7. The translator support program according to claim 6, wherein said displaying means assigns different highlight colors to the units in the next-lower layers when there are a plurality of units in the next-lower layers in said original and translated phrases.

8. The translator support program according to claim 1, wherein said displaying means displays an original phrase and a translated phrase of any unit on said display device and displays the whole of original sentence including said original phrase on said display device.

9. The translator support program according to claim 1, wherein said storing means holds a data structure for each of original sentences in said storage, said data structure stores an original phrase, a translated phrase and identifying information of a unit and identifying information of a unit in the next-upper layer for each of all units in each original sentence, and
wherein said propagating means also performs a process to reflect said correction to translated phrases of units in said storage that are identical to the translated phrase to be corrected by the user's instruction among all units in said plurality of original sentences.

10. The translator support program according to claim 1 that operates a computer as a device further comprising:
means for determining, when a user's instruction to enter an original phrase and a translated phrase displayed on said display device by said displaying means into a database of a translation-memory-retrieval module is accepted, whether a unit in a next-lower layer is established for said original and translated phrases or not: and
means for replacing the unit in the next-lower layer for said original and translated phrases with the same variable when said determining means determines a unit in said next-lower layer is established; and
means for entering them into said database so as to be related to one another.

11. The translator support program according to claim 1 that operates a computer as a device further comprising:
means for entering, when a user's instruction to enter any of all units in said original sentence into a database of a translation-memory-retrieval module is accepted, the original phrase and the translated phrase instructed by the user into said database so as to be related to each other.

12. The translator support program according to claim 1 that operates a computer as a device further comprising:
means for translating the original phrase displayed on said display device by a translation module when a user's instruction to verify the translated phrase displayed on said display device by said displaying means is accepted;
means for extracting different units between said translated phrase displayed on said display device and the translation result generated by said translating means; and
means for highlighting said different units extracted by said extracting means in said translated phrase displayed on said display device.

13. The translator support program according to claim 12, wherein said translation module is a machine translation module.

14. The translator support program according to claim 12, wherein said translation module is a translation-memory-retrieval module.

15. The translator support program according to claim 12, wherein said translating means tries to translate said original phrase displayed on said display device by a translation memory retrieval module, and translates said original phrase by a machine translation module when said translation-memory-retrieval module fails to translate.

16. A translator support program that operates a computer as a device comprising:
a first storing means for storing an original phrase, an identifying information of each of units that are established as translation units in an original sentence, and identifying information of a unit in a next-upper layer that includes said units into storage so as to be related with one another;
a second storing means for storing an original phrase and a translated phrase of each of units whose translation phrases are generated by translating said original phrases, among all the unit in said original sentence into said storage so as to be related with one another;
a displaying means for displaying an original phrase of any unit among all the units in said original sentence;
a translation-memory-retrieval means for retrieving, when a user's instruction to translate the original phrase displayed on said display device by said displaying means, a example phrase that is identical to or similar to said original phrase by a translation-memory-retrieval module;
a translation-result-output means for displaying a translation example corresponding to the example phrase retrieved by said translation-memory-retrieval means on said display device as the translated phrase corresponding to said original phrase; and
a layer-generation means for adding, when an example sentence retrieved by said translation-memory-retrieval means contains a variable, a portion in the original phrase corresponding to said variable as a unit in the next-lower layer into said storage so as to be related with said original phrase.

17. The translator support program according to claim 16 that operates a computer as a device further comprising:
means for translating the original phrase of the unit that is added by said layer-generation means by a translation module;
means for replacing said variable in the translation phrase displayed by said translation-result-output means on said display device with the translation result generated by said translating means; and
means for storing the replaced translated phrase and the original phrase displayed on said display device into said storage as a pair.

18. A translator support device comprising:
a storing portion for storing an original phrase, a translated phrase and identifying information of each of units that are established as translation units in a original sentence, and identifying information of a unit in a next-upper layer that includes said units so as to be related with one another;
a displaying portion for displaying an original phrase and a translated phrase of any of all units in said original sentence;
a retrieving portion for retrieving units, when a user's instruction to correct a translated phrase displayed on said displaying portion is accepted, that includes parts to be corrected from units established in said translated phrase as lower layers; and
a propagating portion for propagating the correction by repeating a process to reflect the correction to a translated phrase in each of units in all the layers retrieved by said retrieving portion from the lowermost layer to the uppermost layer.

19. A translator support method comprising:
a storing procedure for storing an original phrase, a translated phrase and identifying information of each of units that are established as translation units in a original sentence, and identifying information of a unit in a next-upper layer that includes said units into storage so as to be related with one another;
a displaying procedure for displaying an original phrase and a translated phrase of any of all units in said original sentence on a display device;
a retrieving procedure for making a computer retrieve units, when a user's instruction to correct a translated phrase displayed on said display device in said displaying procedure is accepted, that includes parts to be corrected from units established in said translated phrase as lower layers; and
a propagating procedure for making a computer propagate the correction by repeating a process to reflect the correction to a translated phrase in each of units in all the layers retrieved in said retrieving procedure from the lowermost layer to the uppermost layer.
